(19) United States
(12) Patent Application Publication
(10) Pub. No.: US 2025/0250775 A1
(43) Pub. Date: Aug. 7, 2025

(54) LOCK INDICATOR ARRANGEMENT AND METHOD FOR A QUICK COUPLER AND QUICK COUPLER COMPRISING THE SAME

(71) Applicant: STEELWRIST AB, Rosersberg (SE)

(72) Inventor: Axel WALL, Knivsta (SE)

(73) Assignee: STEELWRIST AB, Rosersberg (SE)

(21) Appl. No.: 18/856,244

(22) PCT Filed: Apr. 13, 2023
(86) PCT No.: PCT/SE2023/050346

§ 371 Date: Oct. 11, 2024

(30) Foreign Application Priority Data
Apr. 13, 2022 (SE) 2250459-1

(51) Int. Cl. E02F 9/26; E02F 3/36

(52) U.S. Cl. CPC E02F 9/264; E02F 3/364

(57) ABSTRACT

A lock indicator arrangement (100) for a quick coupler (10) for attaching a tool (20) to a working machine (1), the lock indicator arrangement (100) comprises a locking device (19), comprising a first locking pin and second locking pin (13a, 13b), wherein the first locking pin (13a) is configured to rotate around the first locking pin center axis (13a′), in relation to the frame (11), between a first and second rotation position, wherein the first and second locking pin (13a, 13b) comprises comprising a first and second wedge surface portion (15a, 15b), respectively, configured to engage with the first attachment device (22a) of the tool (20), during an attachment of the tool (20), wherein the first locking pin (13a) is configured to rotate from the first rotation position to the second rotation position, during the movement from the retracted to the extended position, when the first wedge surface portion (15a) engage with the first attachment device (22a), wherein the extended position and second rotation position of the first locking pin (13a), forms a locked position of the tool (20) received in the first tool receiving portion (12), wherein the lock indicator arrangement (100) further comprises a first sensor device (16a), wherein the first sensor device (16a) is configured to sense at least when the first locking pin (13a), is in the second rotation position.

### TECHNICAL FIELD

The present invention relates generally to a lock indicator arrangement and method for a quick coupler for attaching a tool to a working machine, and a quick coupler comprising the same.

It is known to use sensors in quick couplers for attaching tools or implements to working machines with the aim to provide an indication of whether the tool has been correctly locked to the quick coupler or not. Known solutions has e.g. proposed sensor units on the tool as well as corresponding detection units on the yoke of the quick coupler. It has also been proposed to provide sensors in the frame for verifying the engagement with the fastening pins of the tool in combination with providing a position sensor on a rod connected to a locking wedge which engage with the fastening pins during attachment of the tool. The position sensor being adapted to verify the position of the locking wedge and indicate that the looking wedge has reached and occupies the correct locking position. It has further been proposed to provide sensors measuring the position of locking pins engaging in circular holes of the tool for attachment.

A drawback of known solutions is that the sensors measuring the position of locking wedges or locking pins are generally exposed to the outside environment. Sensors are generally sensitive to dirt, dust and debris, which at the same time is part of the environment of where earth moving machines is operated. Thus, the sensors require continuous maintenance and cleaning to function properly, a fact that reduces their reliability and robustness during operation in a mining environment. Further, the sensors generally require certain adaption in the frame of the quick coupler to fit the sensors, which is also expensive from a manufacturing standpoint. A further drawback of the known solutions is that the sensors and/or the required infrastructure for providing the necessary electrical energy to the same are more cumbersome and time consuming to install and replace.

A further drawback of known solutions is that they may provide false positive indications of a correct locking situation if the locking wedge or pins have been incorrectly extended above or outside the fastening pins or holes during a locking procedure. This case of error results in a potentially dangerous situation where the tool is not correctly locked to the quick coupler, but the operator is unaware of this fact and continues the operation. A further drawback of the known solution is that they require a plurality of exposed sensor devices to seek to overcome this case of error, which are expensive and require continuous maintenance and control of the sensors as stated above.

Yet another drawback of known solutions is that they do not provide redundancy with respect to the locking pin positions connected to a common yoke, which reduces their reliability and safety further.

Yet another drawback of known solutions is that sensor devices require complex and expensive wiring. In the case of e.g. tilt rotator applications, the systems require electrical swivel devices to enable rotational movement of the tool with maintained sensing capabilities.

### SUMMARY OF INVENTION

An object of the present invention is to alleviate some of the disadvantages of the prior art and to provide a lock indicator arrangement and method for a quick coupler for attaching a tool to a working machine which is more robust, more reliable and safer to use. A further object of the present invention is to provide a lock indicator arrangement and method for a quick coupler for attaching a tool to a working machine which is cheaper to manufacture, install and maintain.

According to one embodiment, a lock indicator arrangement for a quick coupler for attaching a tool to a working machine is provided, the tool comprising an attachment bracket comprising a first attachment device, wherein the quick coupler further comprises a frame with a first tool receiving portion for receiving the first attachment device, the lock indicator arrangement comprises a locking device, comprising a first locking pin and second locking pin, wherein the first locking pin and second locking pin comprises a first locking pin center axis and a second locking pin center axis, respectively, extending in a first locking pin extension direction and a second locking pin extension direction, respectively, wherein the locking device is configured to move in relation to the frame, wherein the first locking pin and the second locking pin are configured to move between a retracted position and an extended position, respectively, in the first locking pin extension direction and second locking pin extension direction, respectively, wherein the first and second locking pins delimit the first tool receiving portion in their extended positions, respectively, wherein the first locking pin is configured to rotate around the first locking pin center axis, in relation to the frame, between a first and second rotation position, wherein the first and second locking pin comprises a first and second distal end portion comprising a first and second wedge surface portion, respectively, configured to engage with the first attachment device of the tool, during an attachment of the tool, wherein the first locking pin is configured to rotate from the first rotation position to the second rotation position, during the movement from the retracted to the extended position, when the first wedge surface portion engage with the first attachment device, wherein the extended position and second rotation position of the first locking pin, forms a locked position of the tool received in the first tool receiving portion, wherein the lock indicator arrangement further comprises a first sensor device, wherein the first sensor device is configured to sense at least when the first locking pin is in the second rotation position.

According to one embodiment, the second locking pin is configured to rotate around the second locking pin center axis, in relation to the frame between a first and second rotation position, wherein the second locking pin is configured to rotate from the first rotation position to the second rotation position, during the movement from the retracted to the extended position, when the second wedge surface portion engage with the first attachment device, wherein the extended position and second rotation position of the second locking pin, forms a locked position of the tool received in the first tool receiving portion, wherein the lock indicator arrangement further comprises a second sensor device, wherein the second sensor device is configured to sense at least when the second locking pin, is in the second rotation position.

According to one embodiment, the first and second locking pins are biased towards the first rotation position by a first and second spring device, respectively.

According to one embodiment, the first and second locking pins are configured to rotate independently of each other.

According to one embodiment, the first and second sensor devices are arranged inside the first and second locking pins, respectively.

According to one embodiment, the first and second sensor devices are arranged inside a yoke of the locking device.

According to one embodiment, the first and second wedge surface portions are configured to engage with a first attachment device engagement surface portion, wherein the first and second wedge surface portions comprise a first and second wedge surface portion plane with a first and second wedge surface plane outward normal direction, respectively, wherein the first attachment device engagement surface portion has a first attachment device engagement surface portion inward normal direction wherein the first and second wedge surface portion plane outward normal direction are arranged with an angle (α1, α2), respectively, in relation to the first attachment device engagement surface portion inward normal direction during the attachment of the tool, wherein the angles (α1, α2) are in the interval of 0°<(α1, α2)≤90°, in the first rotation positions.

According to one embodiment, the angles (α1, α2)=0° in the second rotation positions.

According to one embodiment, the first and second locking pin comprises a first and second guiding wedge surface portion, respectively, wherein the first and second guiding wedge surface portion comprise a first and second guiding wedge surface portion plane with a first and second guiding wedge surface portion plane outward normal direction, respectively, wherein the first and second guiding wedge surface portion plane outward normal direction are arranged with an angle (β1, β2), respectively, in relation to the first attachment device engagement surface portion inward normal direction in the first rotation positions during the attachment of the tool, wherein β1<α1, and β2<α2.

According to one embodiment, the first and second locking pin comprises a first and second radio unit, a first and second battery device and the first and second sensor device, respectively, wherein the first and second radio units are configured to transmit radio signals comprising data from the first and second sensor devices, respectively.

According to one embodiment, a quick coupler for attaching a tool is provided, comprising a lock indicator arrangement according to any of the embodiments herein, e.g. the embodiments of paragraphs [0008]-[0017].

According to one embodiment, the quick coupler further comprising a central radio unit arranged on the frame configured to transmit radio signals comprising data from the first and second sensor devices.

According to one embodiment, the quick coupler further comprising at least one proximity sensor device configured for sensing an engagement between the quick coupler and at least the first attachment device, wherein the at least one proximity sensor device is connected to the central radio unit, wherein the central radio unit is further configured to transmit radio signals comprising data from the at least one proximity sensor device.

According to one embodiment, a working machine is provided, comprising a quick coupler according to any of the embodiments herein, e.g. the embodiments of paragraphs [0018]-[0020].

According to one embodiment, a method performed by a lock indicator arrangement for a quick coupler according to any of the embodiments herein, e.g. the embodiments of paragraphs [0008]-[00017], is provided, the method comprising: receiving a lock indication request signal, requesting a first locking pin position signal from the first sensor device, receiving a first locking pin position signal based on the sensed position of the first locking pin, respectively, transmitting a first locking pin position indication signal based on the first locking pin position signal.

According to one embodiment, the method further comprising: requesting a second locking pin position signal from the second sensor device, receiving a second locking pin position signal based on the sensed position of the second locking pin, transmitting a second locking pin position indication signal based on the second locking pin position signal.

According to one embodiment, the first and second locking pin position indication signal is indicative of whether the first and second locking pin is in the first or the second rotation position.

According to one embodiment, the first and second locking pin position indication signal is transmitted to an operator's cabin of a working machine.

According to one embodiment, the first and second locking pin position indication signal is transmitted to the operator's cabin wirelessly via a radio unit, or via a wire.

According to one embodiment, the method further comprises: receiving a lock activation indicating signal, providing a warning signal to an operator's cabin if either of the first and second locking pin position signal indicates that the first or second locking pin position is not a second rotation position after a predefined period of time.

According to one embodiment, the warning signal is any or all of an audible, visible, or haptic signal.

According to one embodiment, a lock indicator arrangement according to any of the embodiments herein, e.g. the embodiments of paragraphs [0008]-[0017], is provided, further comprising: processing circuitry; and a memory, said memory containing instructions executable by said processing circuitry, whereby said arrangement is operative for: receiving a lock indication request signal, requesting a first locking pin position signal from the first sensor device, receiving a first locking pin position signal based on the sensed position of the first locking pin, transmitting a first locking pin position indication signal based on the first locking pin position signal.

According to one embodiment, the lock indicator arrangement is further operative for requesting a second locking pin position signal from the second sensor device, receiving a second locking pin position signal based on the sensed position of the second locking pin, transmitting a second locking pin position indication signal based on the second locking pin position signal.

According to one embodiment, the lock indicator arrangement is further operative for performing the method according to any of the embodiments herein, e.g. the embodiments of paragraphs [0022]-[0028].

According to one embodiment, a computer program comprising computer readable code means to be run in a lock indicator arrangement for a quick coupler for attaching a tool to a working machine, is provided, which computer readable code means when run in the arrangement causes the arrangement to carry out the method according to any of the embodiments herein, e.g. the embodiments of paragraphs [0022]-[0028].

According to one embodiment, a carrier containing the computer program (605) according to paragraph is provided, wherein the carrier is one of an electronic signal, optical signal, radio signal or computer readable storage medium.

According to one embodiment, a first locking pin for a lock indicator arrangement according to any of the embodiments herein, e.g. the embodiments of paragraphs [0008]-[0017], [0029]-[0031] is provided, comprising a first locking pin center axis, extending in a first locking pin extension direction, a first distal end portion comprising a first wedge surface portion, wherein the first locking pin is essentially cylinder shaped, wherein a surface portion of the first locking pin comprises a first guiding groove comprising a first extension guiding groove section extending along the first locking pin extension direction, wherein the first extension guiding groove section is configured to engage with a first spring ball device comprising a first ball and a first spring device, biasing the first locking pin towards a first rotation position during an attachment of the tool.

According to one embodiment, the first guiding groove further comprises a first retraction guiding groove section extending with a groove angle γ in relation to the first extension direction, wherein the first retraction guiding groove section is configured to engage with the first spring ball device, forcing the first locking pin towards the first rotation position during a movement towards a retracted position of the first locking pin.

According to one embodiment, the groove angle γ is in the interval of 95°≤γ≤175°, preferably 105°≤γ≤165°, more preferably 115°≤γ≤155°.

According to one embodiment, the first locking pin comprises a first radio unit, a first battery device and the first sensor device, wherein the first radio unit is configured to transmit radio signals comprising data from the first sensor device, respectively.

According to one embodiment, the radio unit is arranged at the first distal end portion, and the first sensor device is arranged at a proximal end portion, wherein the first battery device is arranged between the first radio unit and the first sensor device.

According to one embodiment, the first locking pin further comprising an opening configured to enable access to the first battery device for replacing the first battery device via an openable lid configured to cover the opening.

According to one embodiment of a lock indicator arrangement, α₁=α₂ in the first rotation positions.

According to one embodiment, the first and second wedge surface plane outward normal direction, intersect in the first rotation position.

According to one embodiment, the first and second wedge surface plane outward normal direction, are parallel in the first rotation position.

According to one embodiment, the first and second wedge surface plane outward normal direction, are non-parallel in the first rotation position.

According to one embodiment, the first and second locking pins are essentially cylinder shaped.

According to one embodiment, the first and second locking pins are fully inserted in the frame in the retracted position and protrude out from the frame with their distal end portions through a first and second locking pin opening, respectively, in the extended position.

According to one embodiment, the first and second sensor device is one of a strain gauge, an inductive sensor, or an angular position sensor.

According to one embodiment, the first and second locking pin, comprises a first and second sensor device interaction surface, respectively, located on the first and second locking pin, respectively, to be directed away from the first and second sensor device, respectively, in the first rotation positions, wherein the first and second sensor interaction surface are located to face the first and second sensor device, respectively, in the second rotation positions.

According to one embodiment, the first and second sensor device interaction surface are arranged on a proximal end portion of the first and second locking pin, respectively.

According to one embodiment, the first attachment device comprises an attachment pin.

According to one embodiment, the first attachment device comprises two attachment pins.

According to one embodiment, the first attachment device comprises a first and second hole, wherein the first and second locking pins are configured to be inserted in the first and second hole, respectively.

According to one embodiment, the first and second wedge surface portions comprises a first and second wedge surface portion plane with a first and second wedge surface portion plane normal direction, respectively, wherein the first attachment device comprises a first attachment device center axis, wherein the first and second wedge surface portion plane normal direction is arranged with an angle (α₁₁, α₂₂), respectively in relation to the first attachment pin center axis, during attachment of the tool, wherein the angles (α₁₁, α₂₂) are in the interval of 0°≤(α₁₁, α₂₂)<90°, in the first rotation positions.

According to one embodiment, the angles (@11, @22) =90° in the second rotation positions.

According to one embodiment, the first and second locking pin comprises a first and second guiding wedge surface, respectively, wherein the first and second guiding wedge surface comprise a first and second guiding wedge surface plane with a first and second guiding wedge surface plane outward normal direction, respectively, wherein the first and second guiding wedge surface plane outward normal direction are arranged with an angle (β₁₁, β₂₂), respectively, in relation to the first attachment pin center axis, in the first rotation positions during the attachment of the tool, wherein (β₁₁>α₁₁, and β₂₂>α₂₂.

According to one embodiment, the angles (β₁₁, β₂₂)=90° in the first rotation positions.

According to one embodiment of a lock indicator arrangement a surface portion of the first locking pin comprises a first guiding groove comprising a first extension guiding groove section extending along the first locking pin extension direction, wherein the first extension guiding groove section is configured to engage with a first spring ball device comprising a first ball and a first spring, biasing the first locking pin towards a first rotation position during an attachment of the tool.

According to one embodiment of a lock indicator arrangement, the first guiding groove further comprises a first retraction guiding groove section extending with a groove angle γ in relation to the first extension direction, wherein the retraction guiding groove section is configured to engage with the first spring ball device, forcing the first locking pin towards a first rotation position during a movement towards a retracted position of the first locking pin.

According to one embodiment of lock indicator arrangement, the groove angle γ is in the interval of 95°≤γ≤175°, preferably 105°≤γ≤165°, more preferably 115°≤γ≤155°.

According to one embodiment of a lock indicator arrangement, the first locking pin comprises a first radio unit, a first battery device and the first sensor device, wherein the first radio unit is configured to transmit radio signals comprising data from the first sensor device, respectively.

According to one embodiment of a lock indicator arrangement, the first radio unit is arranged at the first distal end portion, and the first sensor device is arranged at a proximal end portion, wherein the first battery device is arranged between the first radio unit and the first sensor device.

According to one embodiment of a lock indicator arrangement, the first locking pin further comprising an opening configured to enable access to the first battery device for replacing the first battery device via an openable lid configured to cover the opening.

According to one embodiment, the first locking pin is in a first rotation position when the first locking pin is in a retracted position.

According to one embodiment of a quick coupler for attaching a tool to a working machine, the quick coupler further comprising a central radio unit arranged on the frame configured to transmit radio signals comprising data from the first and second sensor devices.

According to one embodiment of a quick coupler, further comprising at least one proximity sensor device configured for sensing an engagement between the quick coupler and at least the first attachment device, wherein the at least one proximity sensor device is connected to the central radio unit, wherein the central radio unit is further configured to transmit radio signals comprising data from the at least one proximity sensor device.

### BRIEF DESCRIPTION OF DRAWINGS

The invention will now be described in more detail by means of exemplary embodiments and with reference to the accompanying drawings, in which:

FIG. 1 shows a perspective view of a working machine with a lock indicator arrangement for a quick coupler for attaching a tool, and a quick coupler according to an embodiment.

FIG. 1 further shows an enlarged view of the lock indicator arrangement and quick coupler.

FIG. 2 shows a perspective view of the working machine of FIG. 1 wherein a tool is attached to the quick coupler.

FIG. 2 further shows an enlarged view of the lock indicator arrangement and quick coupler with and an attached tool.

FIG. 3a shows a perspective view of a lock indicator arrangement for a quick coupler according to an embodiment, and a quick coupler.

FIG. 3b shows a side view of a lock indicator arrangement for a quick coupler, and a quick coupler, according to FIG. 3a.

FIG. 3c shows a side view of a lock indicator arrangement for a quick coupler, and a quick coupler, according to FIG. 3a.

FIG. 4a shows a side view of a lock indicator arrangement for a quick coupler according to an embodiment, a quick coupler, and an attachment bracket of a tool, in a retracted position and first rotation position of the first and second locking pin.

FIG. 4b shows cross-section view of a lock indicator arrangement for a quick coupler, and a quick coupler, along line A-A, according to FIG. 4a.

FIG. 5a shows a side view of a lock indicator arrangement for a quick coupler according to an embodiment, a quick coupler, and an attachment bracket of a tool, in an intermediate extension position and intermediate rotation position of the first and second locking pin.

FIG. 5b shows cross-section view of a lock indicator arrangement for a quick coupler, and a quick coupler, along line B-B, according to FIG. 5a.

FIG. 6a shows a side view of a lock indicator arrangement for a quick coupler according to an embodiment, a quick coupler, and an attachment bracket of a tool, in an extended position and second rotation position of the first and second locking pin.

FIG. 6b shows a cross-section view of a lock indicator arrangement for a quick coupler, and a quick coupler, along line C-C, according to FIG. 6a.

FIG. 7a shows a side view of a lock indicator arrangement for a quick coupler according to an embodiment, a quick coupler, and an attachment bracket of a tool, in an extended position of the locking pin, wherein the quick coupler is not correctly locked to an attachment device of the attachment bracket.

FIG. 7b shows a side view of a lock indicator arrangement for a quick coupler according to an embodiment, a quick coupler, and an attachment bracket of a tool in an extended position of the locking pin, wherein the quick coupler is correctly locked to an attachment device of the attachment bracket.

FIG. 8a shows a perspective view of a lock indicator arrangement for a quick coupler according to an embodiment, and a quick coupler, in an intermediate extension position of the first and second locking pin.

FIG. 8b shows a side view of a lock indicator arrangement for a quick coupler, and a quick coupler, according to FIG. 8a.

FIG. 8c shows a side view of a lock indicator arrangement for a quick coupler, and a quick coupler, according to FIG. 8a.

FIG. 9a shows a side view of a lock indicator arrangement for a quick coupler according to an embodiment, and a quick coupler.

FIG. 9b shows cross-section view of a lock indicator arrangement for a quick coupler, and a quick coupler, along line D-D, according to FIG. 9a.

FIG. 9c shows a perspective view of a first or a second locking pin according to an embodiment.

FIG. 9d shows a side view of a first or second locking pin according to FIG. 9c.

FIG. 9e shows a cross-section view of a first or second locking pin, along line E-E, according to FIG. 9d.

FIG. 10a shows a side view of a first or a second locking pin according to an embodiment.

FIG. 10b shows a cross-section view of a first or a second locking pin according to FIG. 10, a lock indicator arrangement comprising the locking pin, and a quick coupler and an attachment bracket of a tool.

FIG. 11a shows a perspective view of a first or a second locking pin in engagement with a first spring device, according to an embodiment.

FIGS. 11b-11d shows side views of a first or a second locking pin according to FIG. 11a.

FIG. 12a shows a perspective view of a first or a second locking pin in engagement with a first spring device, according to an embodiment.

FIGS. 12b-12d shows side views of a first or a second locking pin according to FIG. 12a.

FIG. 13a shows a perspective view of a first or a second locking pin in engagement with a first spring device, according to an embodiment.

FIGS. 13b-13d shows side views of a first or a second locking pin according to FIG. 13a.

FIG. 14a shows a perspective view of a quick coupler for attaching a tool to a working machine, according to one embodiment, comprising a radio unit.

FIG. 14b shows a side view of a quick coupler according to FIG. 14a.

FIG. 14c shows a cross-section view of a quick coupler along line G-G, according to FIG. 14b.

FIG. 15a shows a flow chart schematically showing method steps of an embodiment of a method performed by a lock indicator arrangement for a quick coupler.

FIG. 15b shows a flow chart schematically showing method steps of an embodiment of a method performed by a lock indicator arrangement for a quick coupler.

FIG. 16 shows a flow chart schematically showing method steps of an embodiment of a method performed by a lock indicator arrangement for a quick coupler.

FIG. 17 shows a block schematic of an arrangement 100 according to an embodiment of the invention.

### DETAILED DESCRIPTION

In the following, a detailed description of the invention will be given. In the drawing figures, like reference numerals designate identical or corresponding elements throughout the several figures. It will be appreciated that these figures are for illustration only and are not in any way restricting the scope of the invention.

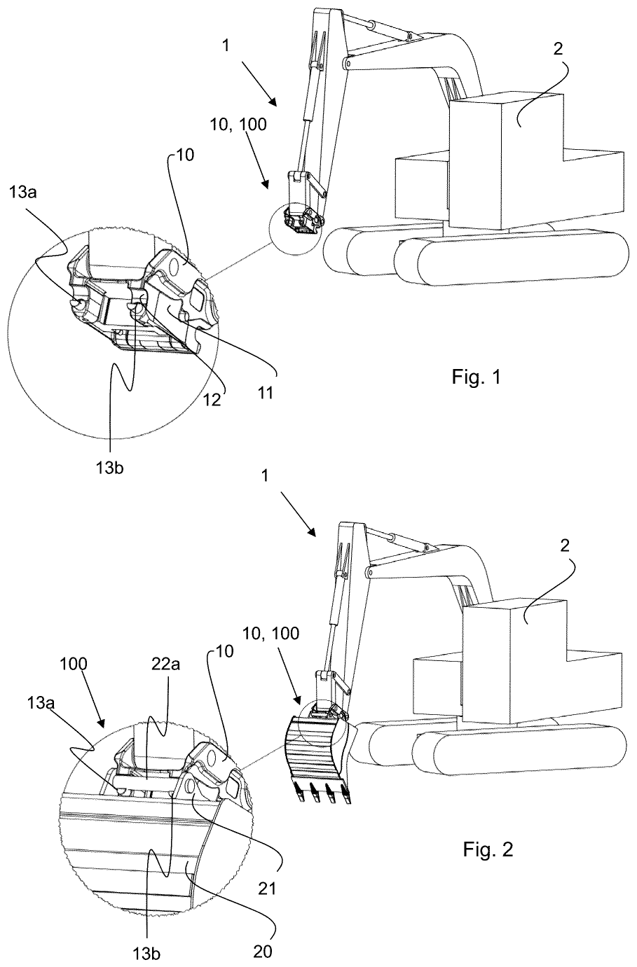

FIG. 1 shows a perspective view of a working machine 1 with a lock indicator arrangement 100 for a quick coupler 10 for attaching a tool 20, and a quick coupler 10, according to an embodiment. According to one embodiment, the working machine 1 is a construction machine. According to one embodiment, the working machine 1 is an earth moving machine. According to one embodiment, the working machine 1 is a demolition machine. According to one embodiment, the working machine 1 is any type of heavy machine with a tool arm. According to one embodiment, the working machine is a forestry machine or a wood treatment machine. According to one embodiment the working machine 1 comprises an operator's cabin 2. According to one embodiment, the arrangement 100 may comprise one of e.g. the following: a TEM (Telematics Module), a CEM (Central Electronic Module) or an ECU (Electronic Control Module). What is referred to as arrangement 100 throughout this patent application may also be known as a node. According to one embodiment, the tool 20 comprises an attachment bracket 21 further comprising a first attachment device 22a and a second attachment device 22b. According to one embodiment, the attachment bracket 21 is a tool bracket. According to one embodiment, the first attachment device 22a comprises a first attachment device center axis 22a′. According to one embodiment, the first attachment device 22a comprises a first attachment pin 22a. According to one embodiment, the second attachment device 22b comprises a second attachment pin. According to one embodiment, the first attachment pin 22a extends between two side walls of the attachment bracket 21. According to one embodiment, first attachment pin 22a is a bracket pin. According to one embodiment, the first attachment device 22a comprises two attachment pins, (not shown). According to one embodiment, the two attachment pins are parallelly arranged along the same axis. According to one embodiment, the first attachment device 22a comprises a first and second hole, wherein the first and second locking pins 13a, 13b are configured to be inserted in the first and second hole, respectively (not shown).

FIG. 1 further shows an enlarged view of the lock indicator arrangement 100 and quick coupler 10.

FIG. 2 shows a perspective view of the working machine 1 of FIG. 1 wherein a tool 20 is attached to the quick coupler. FIG. 2 further shows an enlarged view of the lock indicator arrangement 100 and quick coupler 10 with an attached tool 20.

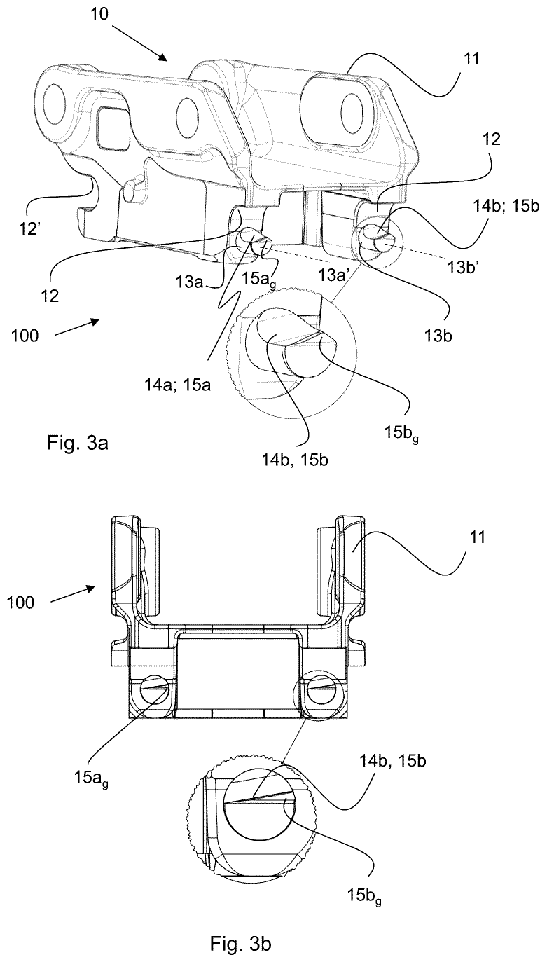

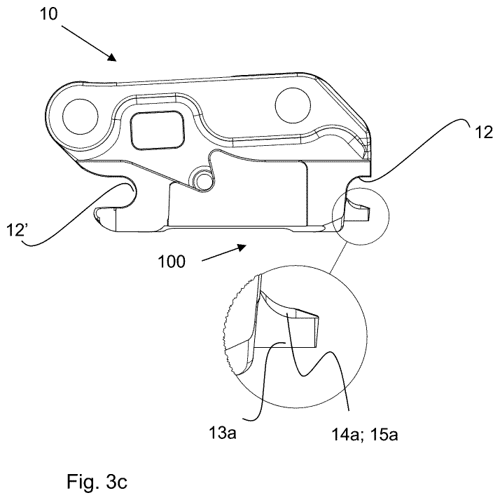

FIG. 3a shows a perspective view of a lock indicator arrangement 100 for a quick coupler 10 according to an embodiment, and a quick coupler 10. According to one embodiment the quick coupler 10 further comprises a frame 11 with a first tool receiving portion 12 for receiving the first attachment device 22a. According to one embodiment the frame 11 comprises a second tool receiving portion 12′ for receiving the second attachment device 22b. According to some embodiments, the first tool receiving portion 12 is configured for receiving any of the first or second attachment pins 22a, 22b. According to one embodiment, the lock indicator arrangement 100 comprises a locking device 19, comprising a first locking pin and second locking pin 13a, 13b, wherein the first locking pin and second locking pin 13a, 13b comprises a first locking pin center axis 13a′ and a second locking pin center axis 13b′, respectively, extending in a first locking pin extension direction and a second locking pin extension direction, respectively. According to one embodiment, the locking device 19 comprises a yoke 18. According to one embodiment, the first and second locking pin 13a, 13b comprises a first and second proximal end portion 14c, 14d, comprising a flange portion providing a relative rotational movability in relation to the yoke 18 and an attachment means in the yoke 18 in the extension direction of the first and second locking pin 13a, 13b. According to one embodiment, the first and second locking pins 13a, 13b are essentially cylinder shaped. According to one embodiment, the first and second locking pins 13a, 13b are cylinder shaped. According to one embodiment, the locking device 19 is configured to move in relation to the frame 11, wherein the first locking pin and the second locking pin 13a, 13b are configured to move between a retracted position and an extended position, respectively, in the first locking pin extension direction and second locking pin extension direction, respectively, wherein the first and second locking pins 13a, 13b delimit the first tool receiving portion 12 in their extended positions, respectively. According to one embodiment, first and second locking pins 13a, 13b delimit the tool receiving portion in their extended position in a direction essentially perpendicular to the first and second locking pin center axis 13a′, 13b′. According to one embodiment, a purpose of delimiting the first tool receiving portion 12 is to lock the tool 20 in the tool receiving portion and prevent movement of the tool 20 in this direction. According to one embodiment, the first and second locking pins 13a, 13b are fully inserted in the frame 11 in the retracted position and protrude out from the frame 11 with their distal end portions 14a, 14b through a first and second locking pin opening, respectively, in the extended position. According to one embodiment, the locking device 19 comprises an actuation device for moving the locking device 19. According to one embodiment, the actuation device is a hydraulic actuation device, such as a hydraulic cylinder. According to one embodiment the actuation device is an electrically operated engine.

According to one embodiment, the first locking pin 13a is configured to rotate around the first locking pin center axis 13a′, in relation to the frame 11, between a first and second rotation position. According to one embodiment, the first and second locking pins 13a, 13b are configured to rotate around the first locking pin and second locking pin center axis 13a′, 13b′, respectively, in relation to the frame 11, between a first and second rotation position. According to one embodiment, the second locking pin 13b is configured to rotate around the second locking pin center axis 13b′, in relation to the frame 11 between a first and second rotation position. According to one embodiment, the first and second locking pin 13a, 13b comprises a first and second distal end portion 14a, 14b comprising a first and second wedge surface portion 15a, 15b, respectively, configured to engage with the first attachment device 22a of the tool 20, during an attachment of the tool 20. According to one embodiment, the first and second locking pins 13a, 13b are biased towards the first rotation position by a first and second spring device 17a, 17b, respectively. According to one embodiment, the first and second locking pins 13a, 13b are configured to rotate independently of each other.

According to one embodiment the first locking pin 13a is configured to rotate from the first rotation position to the second rotation position, during the movement from the retracted to the extended position, when the first wedge surface portions 15a engage with the first attachment device 22a, wherein the extended position and second rotation position of the first locking pin 13a, forms a locked position of the tool 20 received in the first tool receiving portion 12. According to one embodiment, the engagement between the wedge surface portion 15a and the first attachment device 22a provides for a part of the rotation between the first and second rotation position of the first locking pin 13a. According to one embodiment the first locking pin 13a is configured to rotate at least partly from the first rotation position to the second rotation position, during the movement from the retracted to the extended position, when the first wedge surface portions 15a engage with the first attachment device 22a, wherein the extended position and second rotation position of the first locking pin 13a, forms a locked position of the tool 20 received in the first tool receiving portion 12. According to one embodiment the first locking pin 13a is configured to rotate at least partly between the first rotation position up to the second rotation position, during the movement from the retracted to the extended position, when the first wedge surface portions 15a engage with the first attachment device 22a, wherein the extended position and second rotation position of the first locking pin 13a, forms a locked position of the tool 20 received in the first tool receiving portion 12. According to one embodiment the first locking pin 13a is configured to rotate at least partly between the first rotation position up to and including the second rotation position, during the movement from the retracted to the extended position, when the first wedge surface portions 15a engage with the first attachment device 22a, wherein the extended position and second rotation position of the first locking pin 13a, forms a locked position of the tool 20 received in the first tool receiving portion 12. According to one embodiment the first locking pin 13a is configured to rotate at least partly between the first rotation position to and including the second rotation position, during the movement from the retracted to the extended position, when the first wedge surface portions 15a engage with the first attachment device 22a, wherein the extended position and second rotation position of the first locking pin 13a, forms a locked position of the tool 20 received in the first tool receiving portion 12. According to one embodiment, the extended position and second rotation position of the first locking pin 13a, forms a locked position of the first attachment device 22a received in the first tool receiving portion 12. According to one embodiment, the second locking pin 13b is configured to rotate from the first rotation position to the second rotation position, during the movement from the retracted to the extended position, when the second wedge surface portion 15b engage with the first attachment device 22a, wherein the extended position and second rotation position of the second locking pin 13b, forms a locked position of the tool 20 received in the first tool receiving portion 12. According to one embodiment, the engagement between the wedge surface portion 15b and the first attachment device 22a provides for a part of the rotation between the first and second rotation position of the second locking pin 13b. According to one embodiment, the second locking pin 13b is configured to rotate at least partly from the first rotation position to the second rotation position, during the movement from the retracted to the extended position, when the second wedge surface portion 15b engage with the first attachment device 22a, wherein the extended position and second rotation position of the second locking pin 13b, forms a locked position of the tool 20 received in the first tool receiving portion 12. According to one embodiment, the second locking pin 13b is configured to rotate at least partly between the first rotation position to the second rotation position, during the movement from the retracted to the extended position, when the second wedge surface portion 15b engage with the first attachment device 22a, wherein the extended position and second rotation position of the second locking pin 13b, forms a locked position of the tool 20 received in the first tool receiving portion 12. According to one embodiment, the first and second locking pin 13a, 13b are configured to rotate from the first rotation position to the second rotation position, during the movement from the retracted to the extended position, when the first and second wedge surface portions 15a, 15b engage with the first attachment device 22a, wherein the extended position and second rotation position of the first and second locking pin 13a, 13b, forms a locked position of the tool 20 received in the first tool receiving portion 12. According to one embodiment, the first and second locking pin 13a, 13b are caused to rotate from the first rotation position to the second rotation position, during the movement from a retracted towards an extended position, upon the engagement with the first attachment device 22a. According to one embodiment, the first locking pin 13a is caused to rotate from the first rotation position to the second rotation position, during the movement from a retracted towards an extended position, upon the engagement with the first attachment device 22a. According to one embodiment, the second locking pin 13b is caused to rotate from the first rotation position to the second rotation position, during the movement from a retracted towards an extended position, upon the engagement with the first attachment device 22a. According to one embodiment, the first and second locking pin 13a, 13b are caused to rotate at least a part of the rotation from the first rotation position to the second rotation position, during the movement from a retracted towards an extended position, upon the engagement with the first attachment device 22a. According to one embodiment, the first locking pin 13a is caused to rotate at least a part of the rotation from the first rotation position to the second rotation position, during the movement from a retracted to an extended position, upon the engagement with the first attachment device 22a. According to one embodiment, the second locking pin 13b is caused to rotate at least a part of the rotation from the first rotation position to the second rotation position, during the movement from a retracted to an extended position, upon the engagement with the first attachment device 22a. According to one embodiment, the first and second locking pin 13a, 13b are caused to rotate from the first rotation position to the second rotation position, during the movement from a retracted to an extended position, upon the engagement with the first attachment device 22a. According to one embodiment, the first locking pin 13a is caused to rotate from the first rotation position to the second rotation position, during the movement from a retracted to an extended position, upon the engagement with the first attachment device 22a. According to one embodiment, the second locking pin 13b is caused to rotate from the first rotation position to the second rotation position, during the movement from a retracted to an extended position, upon the engagement with the first attachment device 22a. According to one embodiment, the first and second locking pin 13a, 13b are caused to rotate at least a part of the rotation from the first rotation position to the second rotation position, during the movement from a retracted to an extended position, upon the engagement with the first attachment device 22a. According to one embodiment, the first locking pin 13a is caused to rotate at least a part of the rotation from the first rotation position to the second rotation position, during the movement from a retracted to an extended position, upon the engagement with the first attachment device 22a. According to one embodiment, the second locking pin 13b is caused to rotate at least a part of the rotation from the first rotation position to the second rotation position, during the movement from a retracted to an extended position, upon the engagement with the first attachment device 22a.

According to one embodiment, the first locking pin 13a being caused to rotate means or also means or comprises that the first locking pin 13a is configured to be caused to rotate. According to one embodiment, the second locking pin 13b being caused to rotate also means or means or comprises that the second locking pin 13b is configured to be caused to rotate. According to one embodiment, for embodiments relating to the first locking pin 13a, upon the engagement with the first attachment device 22a, means or comprises upon engagement between the first wedge surface portion 15a and the first attachment device 22a. According to one embodiment, for embodiments relating to the second locking pin 13b, upon the engagement with the first attachment device 22a, means or comprises upon engagement between the second wedge surface portion 15b and the first attachment device 22a. According to one embodiment, at least a part of the rotation from the first rotation position to the second rotation position comprises a rotation between an intermediate rotation position and a second rotation position. According to one embodiment, at least a part of the rotation from the first rotation position to the second rotation position comprises a rotation from an intermediate rotation position to and including the second rotation position. According to one embodiment at least a part of the rotation from the first rotation position to the second rotation position comprises a rotation between the first rotation position and the second rotation position. According to one embodiment at least a part of the rotation from the first rotation position to the second rotation position comprises a rotation from the first rotation position to the second rotation position.

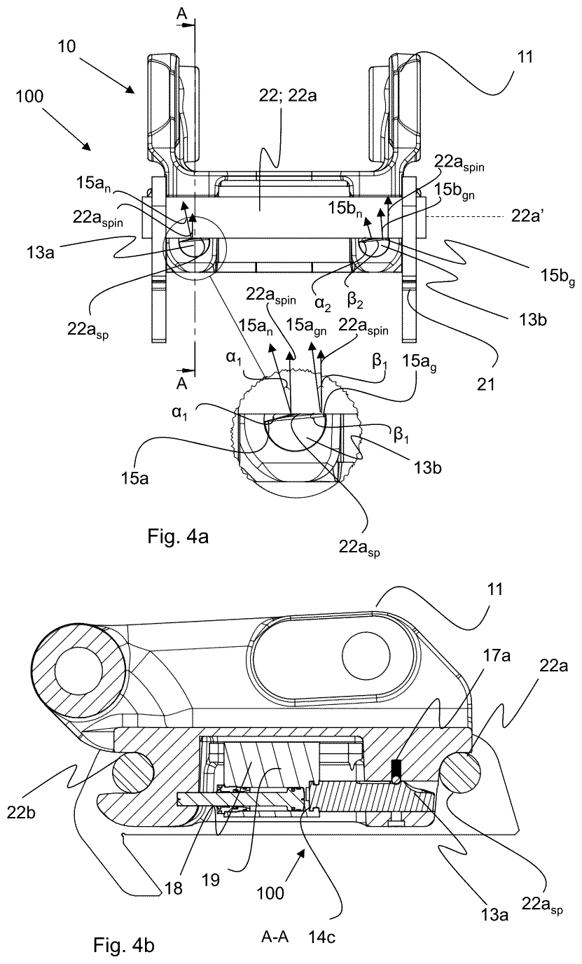

According to one embodiment, the first locking pin 13a is in a first rotation position when the first locking pin 13a is in a retracted position. According to one embodiment, the second locking pin 13b is in a first rotation position when the second locking pin 13b is in a retracted position. According to one embodiment, the first rotation position when the first locking pin 13a or second locking pin 13b is in a retracted position is a retracted rotation position of the first and second locking pin 13, 13b respectively. According to one embodiment, the first rotation position when the first locking pin 13a or second locking pin 13b is in a retracted position is a retracted first rotation position of the first and second locking pin 13a, 13b, respectively. According to one embodiment, the first locking pin 13a is in a first rotation position when the first locking pin 13a is in an intermediate extension position. According to one embodiment, the second locking pin 13b is in a first rotation position when the second locking pin 13b is in an intermediate extension position. According to one embodiment, the first locking pin 13a is in a first rotation position when the first locking pin 13a is in an intermediate extension position between the retracted and extended position. According to one embodiment, the second locking pin 13b is in a first rotation position when the second locking pin 13b is in an intermediate extension position between the retracted and extended position. According to one embodiment, the first locking pin 13a is in a first rotation position when the first locking pin 13a is in a position between the retracted and extended position. According to one embodiment, the second locking pin 13b is in a first rotation position when the second locking pin 13b is in a position between the retracted and extended position. According to one embodiment, the first rotation position is not a maximal counterclockwise rotation position of the first locking pin 13a or second locking pin 13b, e.g. as seen from a direction of FIG. 4a. According to one embodiment, the retracted first rotation position is a maximal counterclockwise rotation position of the first locking pin 13a or second locking pin 13b.

According to one embodiment, the wedge surface portion 15a, 15b of the first and second locking pin 13a, 13b provides the translation of a linear movement into a rotational movement upon the engagement with the first attachment device 22a.

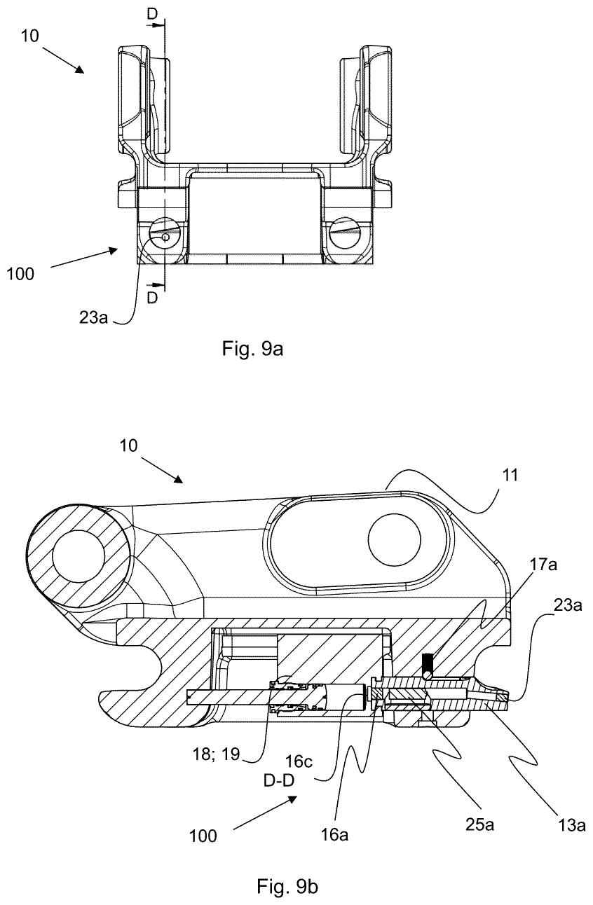

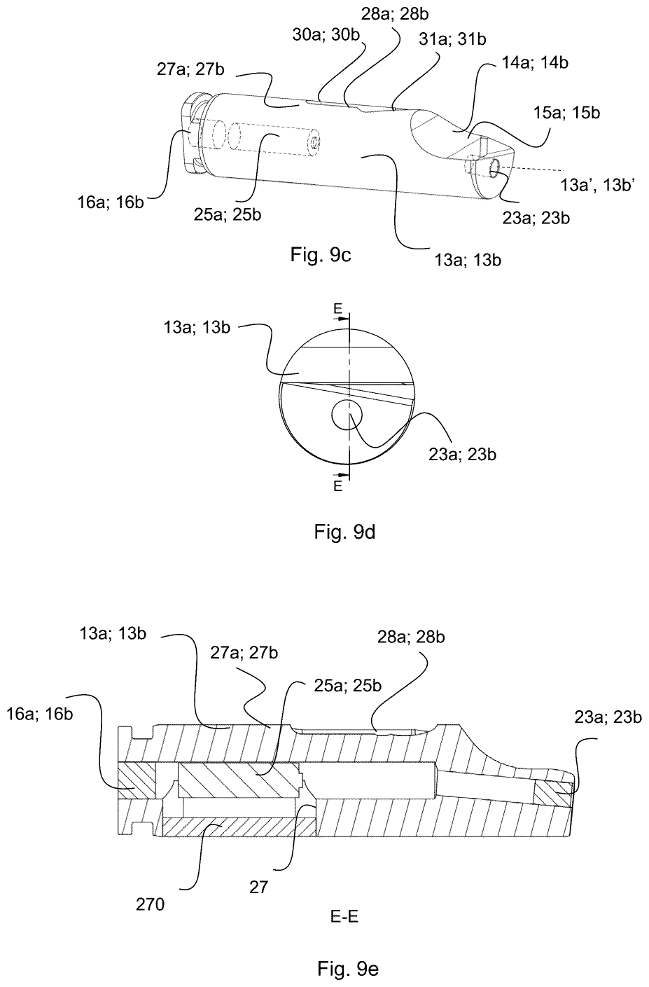

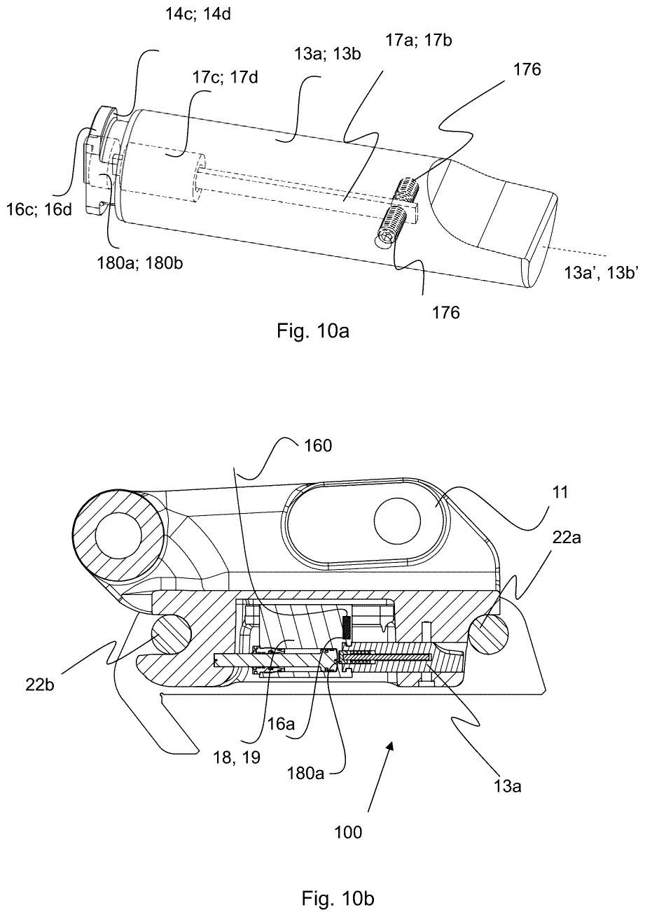

According to one embodiment, as can be further seen in e.g. FIG. 9b, 9c the lock indicator arrangement 100 further comprises a first sensor device 16a, wherein the first sensor devices 16a is configured to sense at least when the first locking pin 13a, is in the second rotation position. According to one embodiment, the first sensor device 16a is configured to sense when the first locking pin 13a, is in the first rotation position. According to one embodiment, the lock indicator arrangement 100 further comprises a second sensor device 16b, wherein the second sensor device 16b is configured to sense at least when the second locking pin 13b, is in the second rotation position. According to one embodiment, the second sensor device 16b is configured to sense when the second locking pin 13b, is in the first rotation position. According to one embodiment, the lock indicator arrangement 100 further comprises a first and second sensor device 16a, 16b, wherein the first and second sensor devices 16a, 16b are configured to sense at least when the first and second locking pin 13a, 13b is in the second rotation position, respectively. According to one embodiment, the first and second sensor devices 16a, 16b are arranged inside the first and second locking pins 13a, 13b, respectively, as will be further described in connection with FIGS. 9a-9e below. According to one embodiment, the first and second sensor devices 16a, 16b are arranged inside a yoke 18 of the locking device 19, as will be further described in connection with FIGS. 10a-10b below. According to one embodiment, the first and second sensor 16a, 16b device is one of a strain gauge, an inductive sensor, or an angular position sensor. According to one embodiment the first and second sensor device 16a, 16b interacts with a magnet arranged either in the yoke 18 or on the first and second locking pin 13a, 13b, depending on where the first and second sensor device 16a, 1b is arranged. According to one embodiment the magnet is arranged opposed to the first and second sensor device 16a, 16b, respectively. According to one embodiment, the first and second sensor device 16a, 16b is configured to sense the magnetic field of the magnet. According to one embodiment, the strength of the magnetic field is indicative of a rotational position in relation to the magnet. According to one embodiment, the first and second rotational position corresponds to a rotational position in relation to the magnet. According to one embodiment, a sensor device interaction surface comprises the magnet.

FIG. 3b shows a side view of a lock indicator arrangement 100 for a quick coupler 10, and a quick coupler 10, according to FIG. 3a. As can be seen in FIG. 3a and FIG. 3b, according to one embodiment, the first and second locking pin 13a, 13b comprises a first and second guiding wedge surface portion 15a_{g}, 15b_{g}, respectively. Further, FIG. 3c shows a side view of a lock indicator arrangement 100 for a quick coupler 10, and a quick coupler 10, according to FIG. 3a.

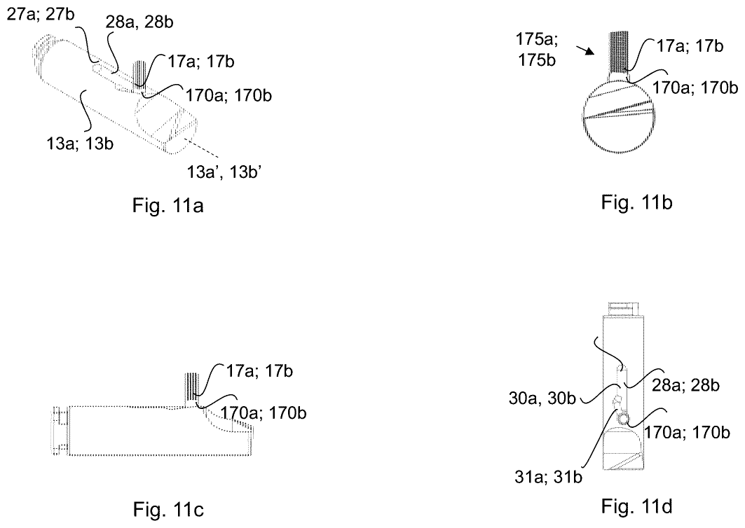

FIG. 4a shows a side view of a lock indicator arrangement 100 for a quick coupler 10 according to an embodiment, a quick coupler 10, and an attachment bracket 21 of a tool 20, in a retracted position and first rotation position of the first and second locking pin 13a, 13b. FIG. 4b shows cross-section view of a lock indicator arrangement 100 for a quick coupler 10, and a quick coupler 10, along line A-A, according to FIG. 4a. According to one embodiment, a biasing force of the first and second spring device 17a, 17b are biasing the first and second locking pin 13a, 13b into the first rotation position. As will be further explained in connection with FIG. 11a-13d, the first rotation position of first and second locking pin 13a, 13b in FIGS. 4a and 4b is a rotation position reached by the aid of an engagement of a first and second guiding groove 28a, 28b, and in particular a retraction guiding groove section 31a, 31b of the first and second guiding groove 28a, 28b respectively, with a first and second spring ball device 175a, 175b comprising the first and second spring device 17a, 17b, respectively.

As shown, according to one embodiment, the first and second guiding wedge surface portion 15a_{g}, 15b_{g} comprise a first and second guiding wedge surface portion plane with a first and second guiding wedge surface portion plane outward normal direction 15a_{gn}, 15b_{gn}, respectively. According to one embodiment, the first attachment device 22a comprises a first attachment device engagement surface portion 22aₛₚ. According to one embodiment, the first and second wedge surface portions 15a, 15b are configured to engage with a first attachment device engagement surface portion 22aₛₚ. According to one embodiment, the first and second wedge surface portions 15a, 15b comprise a first and second wedge surface portion plane with a first and second wedge surface plane outward normal direction 15aₙ, 15bₙ, respectively. According to one embodiment, the first attachment device engagement surface portion 22aₛₚ has a first attachment device engagement surface portion inward normal direction 22aₛₚᵢₙ, wherein the first and second wedge surface portion plane outward normal direction 15aₙ, 15bₙ are arranged with an angle α₁, α₂, respectively, in relation to the first attachment device engagement surface portion inward normal direction 22aₛₚᵢₙ during the attachment of the tool 20, wherein the angles α₁, α₂ are in the interval of 0°<(α₁, α₂)≤90° in the first rotation positions. According to one embodiment, α₁=α₂ in the first rotation positions. According to one embodiment, α₁≠α₂ in the first rotation positions. According to one embodiment, the first and second wedge surface plane outward normal direction 15aₙ, 15bₙ, intersect in the first rotation position. According to one embodiment, the first and second wedge surface plane outward normal direction 15aₙ, 15bₙ, are parallel in the first rotation position. According to one embodiment, the first and second wedge surface plane outward normal direction 15aₙ, 15bₙ, are non-parallel in the first rotation position. According to one embodiment, the outward normal directions 15aₙ, 15bₙ, 15a_{gn}, 15b_{gn}, and inward normal direction 22aₛₚᵢₙ of the surface portions 15a, 15b, 15a_{g}, 15b_{g}, 22aₛₚ, respectively, are defined at the points of the surface portions 15a, 15b, 15a_{g}, 15b_{g}, 22aₛₚ in engagement at a locked position of the tool 20 received in the first tool receiving portion 12.

According to one embodiment, the first and second guiding wedge surface portion plane outward normal direction 15a_{gn}, 15b_{gn} are arranged with an angle β₁, β₂, respectively, in relation to the first attachment device engagement surface portion inward normal direction 22aₛₚᵢₙ in the first rotation positions during the attachment of the tool 20, wherein β₁<α₁, and β₂<α₂. According to one embodiment, the angles β₁, β₂=0° in the first rotation positions.

According to one embodiment, the first and second wedge surface portion plane normal direction 15aₙ, 15bₙ is arranged with an angle α₁₁, α₂₂, respectively in relation to the first attachment pin center axis 22a′, during attachment of the tool 20, wherein the angles α₁₁, α₂₂ are in the interval of 0≤α₁₁, α₂₂<90°, in the first rotation positions. According to one embodiment, the angles α₁₁, α₂₂=90° in the second rotation positions. According to one embodiment, the first and second guiding wedge surface plane outward normal direction 15a_{gn}, 15b_{gn} are arranged with an angle β₁₁, β₂₂, respectively, in relation to the first attachment pin center axis 22a′, in the first rotation positions during the attachment of the tool 20, wherein β₁₁>α₁₁, and β₂₂>α₂₂. According to one embodiment, the angles β₁₁, β₂₂=90° in the first rotation positions.

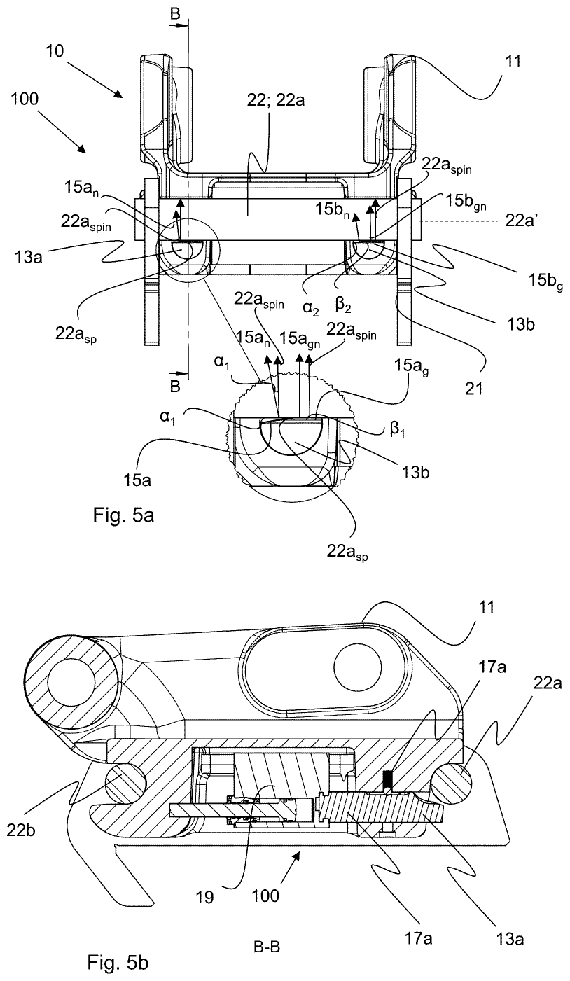

FIG. 5a shows a side view of a lock indicator arrangement 100 for a quick coupler 10 according to an embodiment, a quick coupler 10, and an attachment bracket 21 of a tool 20, in an intermediate extension position and intermediate rotation position of the first and second locking pin 13a, 13b. FIG. 5b shows a cross-section view of a lock indicator arrangement 100 for a quick coupler 10, and a quick coupler 10, along line B-B, according to FIG. 5a. As shown, the first and second locking pins 13a, 13b have been moved with the locking device 18 and the yoke 19, from the retracted position towards the extended position, into an intermediate extension position. As can be seen, according to this embodiment, the angles α₁, α₂, β₁, β₂, are smaller compared to the first rotation position of FIGS. 4a and 4b. According to one embodiment, during this movement, a force will act on the first and second locking pins 13a, 13b following the engagement between the first and second spring ball device 175a, 175b and a proximal edge of the first and second retraction guiding groove section 31a, 31b to rotate the first and second locking pins 13a, 13b from the first rotation position towards the second rotation position into an intermediate rotation position, as will be further described in connection with FIGS. 11a-13d. According to one embodiment, the intermediate rotation position forms a first rotation position. According to one embodiment, the first rotation position is any rotation position up to but not including the second rotation position.

According to one embodiment, during this movement the first and second locking pin 13a, 13b will come into contact with the first attachment device 22a and engage with the first attachment device 22a during a continued movement towards the extended position of the first and second locking pin 13a, 13b. According to one embodiment, the first and second guiding wedge surface portion 15a_{g}, 15b_{g} will be the portions of the first and second locking pins 13a, 13b, respectively to initially engage with the first attachment device engagement surface portion 22aₛₚ of the first attachment device 22a. Due to that fact that β_{1<}α₁, and β_{2<}α₂, initiating a rotational movement is facilitated. According to one embodiment, due to the fact that β_{1<}α₁, and β_{2<}α₂, the risk that no rotational movement is initiated is reduced.

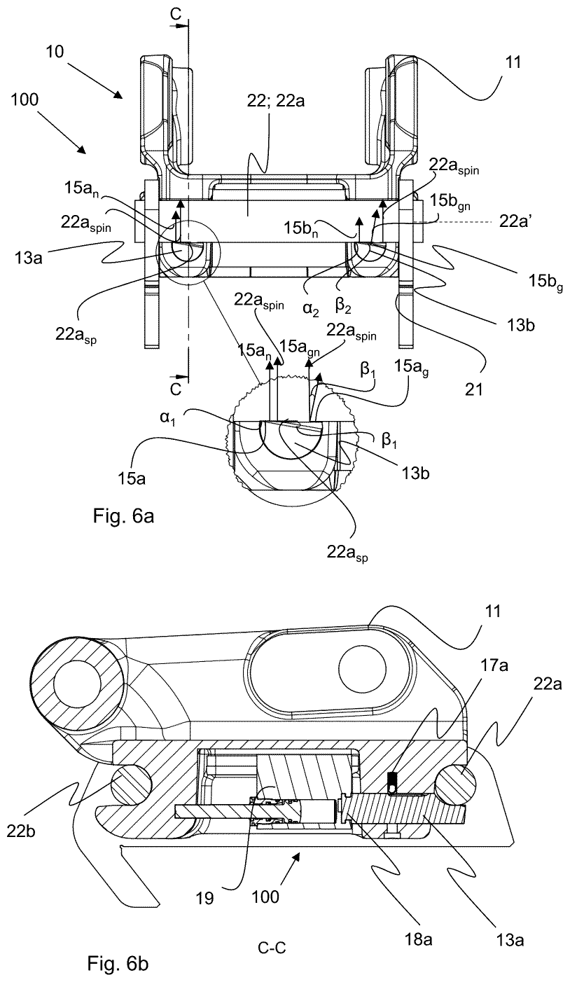

FIG. 6a shows a side view of a lock indicator arrangement 100 for a quick coupler 10 according to an embodiment, a quick coupler 10, and an attachment bracket 21 of a tool 20, in an extended position and second rotation position of the first and second locking pin 13a, 13b. FIG. 6b shows a cross-section view of a lock indicator arrangement 100 for a quick coupler 10, and a quick coupler 10, along line C-C, according to FIG. 6a. As shown, the locking pins 13a, 13b have been moved with the locking device 18 and yoke 19, from the retracted position via an intermediate extension position, towards and into the extended position. As can be seen, according to this embodiment, the angles α₁, α₂, β₁, β₂, are smaller compared to the intermediate rotation position of FIGS. 5a and 5b. In this case, β₁, β₂ are negative angles in view of their definition in FIG. 4a. At the same time, the first and second locking pin 13a, 13b have engaged with the first attachment device 22a of the tool 20, causing the first and second locking pin 13a, 13b to rotate into the second rotation position. According to one embodiment, the extended position and the second rotation position forms a locked position of the tool 20 received in the first tool receiving portion 12. According to one embodiment, during this movement, a force will act on the first and second locking pins 13a, 13b following the engagement between the first and second spring ball device 175a, 175b and an edge of a first and second extension guiding groove section 30a, 30b to bias the first and second locking pins 13a, 13b towards the first rotation position, as will be further described in connection with FIGS. 11a-13d.

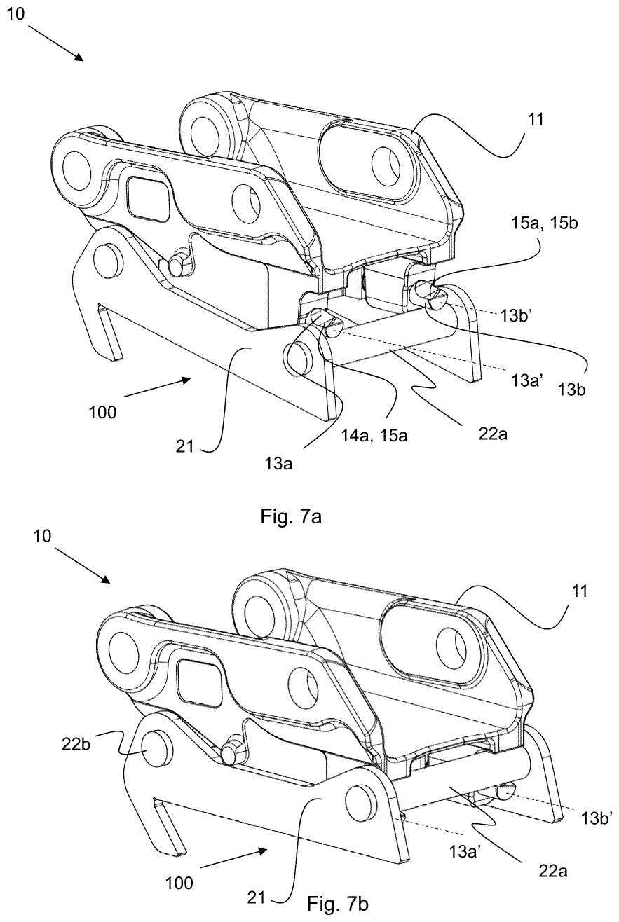

FIG. 7a shows a side view of a lock indicator arrangement 100 for a quick coupler 10 according to an embodiment, a quick coupler 10, and an attachment bracket 21 of a tool 20, in an extended position of the locking pins 13a, 13b, wherein the quick coupler 10 is not correctly locked to the first attachment device 22a of the tool 20. As shown in FIG. 7a, the first and second locking pins 13a, 13b have been brought into an extended position, above the first attachment device 22a. Thus, the first and second wedge surface portion 15a, 15b have not engaged with the first and second locking pins 13a, 13b, which, consequently, have not been brought or caused to rotate into the second rotation position.

FIG. 7b shows a side view of a lock indicator arrangement 100 for a quick coupler 10 according to an embodiment, a quick coupler 10, and an attachment bracket 21 of a tool 20 in an extended position of the first and second locking pin 13a, 13b, wherein the quick coupler 10 is correctly locked to the first attachment device 22a of the tool 20.

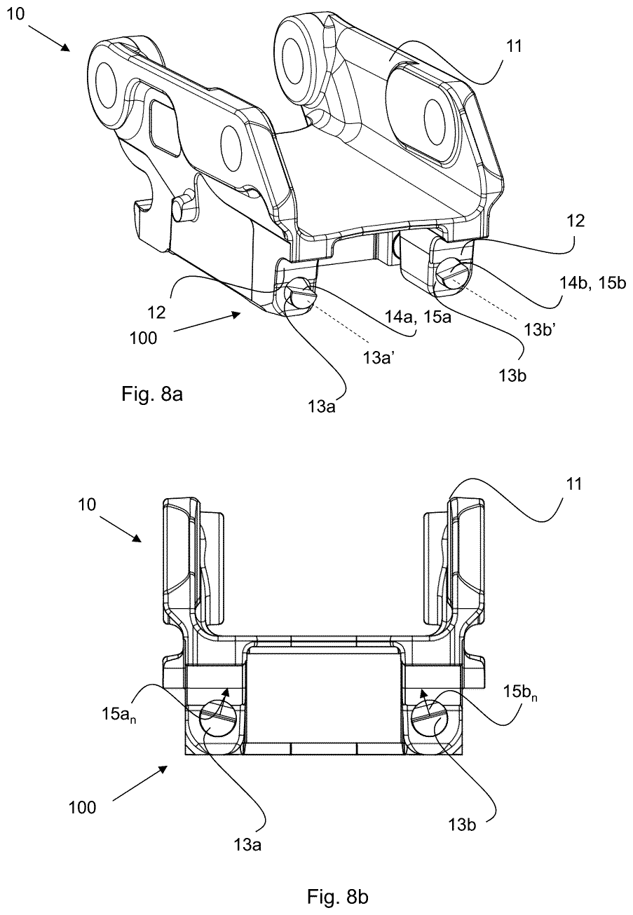

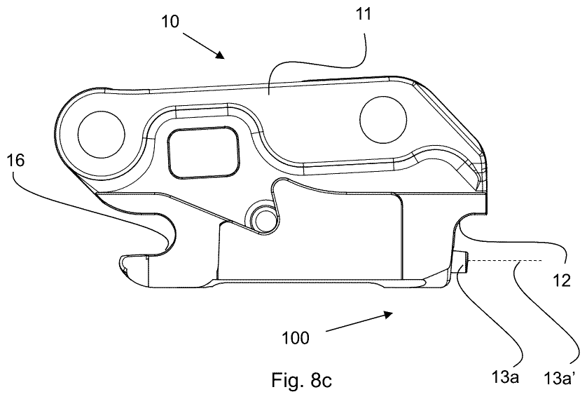

FIG. 8a shows a perspective view of a lock indicator arrangement 100 for a quick coupler 10 according to an embodiment, and a quick coupler 10, in an intermediate extension position of the first and second locking pin 13a, 13b. FIG. 8b shows a side view of a lock indicator arrangement for a quick coupler 10, and a quick coupler 10, according to FIG. 8a. FIG. 8c shows a side view of a lock indicator arrangement 100 for a quick coupler 10, and a quick coupler 10, according to FIG. 8a. According to this embodiment, the first and second locking pins 13a, 13b comprises a first and second distal end portion 14a, 14b comprising a first and second wedge surface portion 15a, 15b. However, the first and second locking pins 13a, 13b do not comprise a first and second guiding wedge surface portion 15a_{g}, 15b_{g}, respectively. According to one embodiment, the first and second locking pins 13a, 13b comprises a first and second distal end portion 14a, 14b comprising solely a first and second wedge surface portion 15a, 15b. The lock indicator arrangement 100 of FIG. 8a, 8b lacks the risk reducing function to initiate the rotation upon engagement with the first attachment device 22a, but otherwise function in the same way as been described for the lock indicator arrangement 100 comprising the first and second guiding wedge surface portion 15a_{g}, 15b_{g}. Furthermore, as shown in this embodiment, in FIG. 8b, the first and second wedge surface plane outward normal direction 15aₙ, 15bₙ, are non-parallel and intersect. According to this embodiment, the first and second wedge surface plane outward normal direction 15aₙ, 15bₙ, are non-parallel and intersect also in the first rotation position.

FIG. 9a shows a side view of a lock indicator arrangement 100 for a quick coupler 10 according to an embodiment, a quick coupler 10, in an extended position of the first and second locking pin 13a, 13b. As can be seen, the first and second locking pin 13a, 13b have not engaged with an attachment device 22a. FIG. 9b shows cross-section view of a lock indicator arrangement 100 for a quick coupler 10, and a quick coupler 10, along line D-D, according to FIG. 9a. As shown, the first locking pin 13a comprises a first radio unit 23a, a first battery device 25a and a first sensor device 16a, wherein the first radio unit 23a is configured to transmit radio signals comprising data from the first sensor device 16a. According to one embodiment, the data comprises rotation position data indicative of the rotation position of the first locking pin 13a, e.g. whether the first locking pin 13a is in a first or second rotation position. According to one embodiment, the second locking pin 13b comprises a second radio unit 23b, a second battery device 25b and a second sensor device 16b, wherein the second radio unit 23b is configured to transmit radio signals comprising data from the second sensor device 16b. According to one embodiment, the data comprises rotation position data indicative of the rotation position of the second locking pin 13b, e.g. whether the second locking pin 13b is in a first or second rotation position. According to one embodiment, the first radio unit 23a is arranged at the first distal end portion 14a, and the first sensor device 16a is arranged at a proximal end portion 14c, wherein the first battery device 25a is arranged between the first radio unit 23a and the first sensor device 23a. According to one embodiment the second locking pin 13b, correspondingly comprises a second radio unit 23b, a second battery device 25b and a second sensor device 16b as described for the first locking pin 13a. According to one embodiment, the yoke 19 comprises a first and second sensor device interaction surface 16c, 16d, respectively. According to one embodiment the sensor device interaction surface is a magnet as described above. According to one embodiment, the sensor device interaction surface is located on the yoke 19 to be directed away from the first and second sensor device 16a, 16b, respectively, in the first rotation positions, wherein the first and second sensor interaction surface 16c, 16d are located to face the first and second sensor device 16a, 16b, respectively, in the second rotation positions.

FIG. 9c shows a perspective view of a first locking pin 13a, or a second locking pin 13b identical to the first locking pin 13a, for a lock indicator arrangement 100, according to an embodiment. FIG. 9d shows a side view of a first locking pin 13a or a second locking pin 13b according to FIG. 9c.

According to one embodiment, FIG. 9c shows a first or second locking pin 13a, 13b for a lock indicator arrangement 100 according to what is described herein. As the first and second locking 13a, 13b are identical according to one embodiment, only the first locking pin 13a will be presented in more detail as follows. The corresponding second locking pin 13b and references follows from the figures. According to one embodiment, the first locking pin 13a comprising first locking pin center axis 13a′, extending in a first locking pin extension direction, a first distal end portion 14a comprising a first wedge surface portion 15a. According to one embodiment, the first locking pin 13a is essentially cylinder shaped. According to one embodiment, a first surface portion 27a of the first locking pin 13a comprises a first guiding groove 28a comprising a first extension guiding groove section 30a extending along the first locking pin extension direction, wherein the first extension guiding groove section 30a is configured to engage with a first spring ball device 175a comprising a first ball 170a and a first spring device 17a, biasing the first locking pin 13a towards a first rotation position during an attachment of the tool 20. According to one embodiment, the first guiding groove 28a further comprises a first retraction guiding groove section 31a extending with a groove angle γ in relation to the first extension direction, wherein the first retraction guiding groove section 31a is configured to engage with the spring ball device 175, forcing the first locking pin 13a towards a first rotation position during a movement towards a retracted position of the first locking pin 13a. Thus, by the use of retraction guiding groove section 31a, a first rotation position is possible that is a rotation position beyond a first rotation position if the first guiding groove 28 solely comprises a first extension guiding groove section 30a. According to one embodiment, the groove angle (γ) is in the interval of 95°≤γ≤175°, preferably 105°≤γ≤165°, more preferably 115°≤γ≤155°. Further, FIG. 9c, with reference to the second locking pin 13b, further shows a second locking pin center axis 13b′, a second distal end portion 14b, a second wedge surface portion 15b, a second surface portion 27b, a second guiding groove 28b, a second extension guiding groove section 30b, a second retraction guiding groove section 31b, a second radio unit 23b, a second battery device 25b, a second sensor device 16b.

FIG. 9e shows a cross-section view of a first or second locking pin 13a, 13b, along line E-E, according to FIG. 9d. According to one embodiment, the first locking pin 13a comprises a first locking pin radio unit 23a, a first battery device 25a and the first sensor device 16a, wherein the first locking pin radio unit 23a is configured to transmit radio signals comprising data from the first sensor device 16a. According to one embodiment, the data comprises rotation position data indicative of the rotation position of the first locking pin 13a, e.g. whether the first locking pin 13a is in a first or second rotation position.

According to one embodiment, the first radio unit 23a is arranged at the first distal end portion 14a, and the first sensor device 16a is arranged at a proximal end portion 14c, wherein the first battery device 25a is arranged between the first radio unit 23a and the first sensor device 23a. According to one embodiment, the arrangement of the of the first radio unit 23a at the first distal end portion 14a provides a location where the radio signals transmitted from the first radio unit 23a are not or at least less attenuated or shielded by the quick coupler 10 or parts thereof. Thus, a more reliable lock indicator arrangement 100 is provided.

According to one embodiment, the first locking pin 13a comprises an opening 27 configured to enable access to the first battery device 25a for replacing the first battery device 25a via an openable lid 270 configured to cover the opening 27. According to one embodiment the openable lid and/or the edge of the opening 27 is configured to provide a seal against outside dirt and moisture. Thus, the replacement of the first battery device 25a is a simple and procedure that can be carried out in an efficient manner. According to one embodiment, the first or second locking pin 13a, 13b is releasably attached to the yoke 18 of the locking device 18. Thus, the first or second locking pin 13a, 13b is easily replaced, e.g. during a maintenance, repair or replacement procedure of the first or second locking pin 13a, 13b.

FIG. 10a shows a side view of a first or a second locking pin 13a, 13b according to an embodiment. As the first and second locking 13a, 13b are identical according to one embodiment, only the first locking pin 13a will be presented in more detail as follows. The corresponding second locking pin 13b and references follows from the figures. According to one embodiment, the first locking pin 13a comprising first locking pin center axis 13a′, extending in a first locking pin extension direction, a first distal end portion 14a comprising a first wedge surface portion 15a. According to one embodiment, the first locking pin 13a is essentially cylinder shaped. According to one embodiment, the first locking pin 13a, is biased towards the first rotation position by a first spring device 17a. According to one embodiment, the first spring device 17a is a first torsion bar 17a extending in the first locking extension direction. According to one embodiment, the first torsion bar 17a is arranged internally of the first locking pin 13a. According to one embodiment a distal end of the first torsion bar 17a is fixedly arranged to the first locking pin 13a by a screw connection device 176. According to one embodiment, the screw connection device 176 comprises two screws 176 arranged via a respective hole with in the first locking pin 13a, comprising an inner threaded surface configured to engage with the screw 176. According to one embodiment, a proximal end of the first torsion bar 17a is connected to a first yoke connecting device 180a via an opening in the proximal end of the first locking pin 13a. According to one embodiment, the proximal end of the first torsion bar 17a is rotationally fixedly arranged in the first yoke connecting device 180a, and the first yoke connecting device 180a is rotationally fixedly arranged in the yoke 18. According to one embodiment, the first yoke connecting device 180 is fixedly arranged in the yoke 18 so that the first locking pin 13a rests in a first rotation position. According to one embodiment, the torsion bar 17a extends through a first sensor unit 17c configured to sense the torsional stress in the torsion bar 17a for determining the rotational position of the first locking pin 13a. According to one embodiment, the sensor unit 17c provides an alternative sensing device for sensing the rotational position. Thus, a relative rotation of the first locking pin 13a in relation to the yoke 18 will cause the torsion bar 17a to twist and bias the first locking pin 13a to rotate in an opposite direction. According to one embodiment, the opposition direction is towards a first rotation position. According to one embodiment, the first spring is a torsion spring. According to one embodiment, the first locking pin 13a comprises a first sensor device interaction surface 16c. According to one embodiment the first sensor device interaction surface 16c is arranged on the proximal end of the first locking pin 13a and located to be directed away from a first sensor device 16a in a first rotation position and located to face the first sensor device 16a in the second rotation position. According to one embodiment, the first sensor interaction surface 16c is arranged on a flange portion forming a first proximal end 14c of the first locking pin 13a. Further, FIG. 10a, with reference to the second locking pin 13b, further shows a second torsion bar 17b, a second yoke connecting device 180b, a second proximal end 14d.

FIG. 10b shows a cross-section view of a first locking pin 13a according to FIG. 10a, a lock indicator arrangement 100 comprising the locking pin 13a, a quick coupler 10 and an attachment bracket 21 of a tool 20. According to one embodiment, the sensor device 16a is arranged in the yoke 18. According to one embodiment, the sensor device 16a is located to face the first sensor device interaction surface 16c. According to one embodiment, the first sensor device 16a is connected to a wire 160. According to one embodiment the first sensor device 16a is connected to the operator's cabin 2 via the wire 160. According to one embodiment, the first sensor device 16a is connected to a central radio unit 26 via the wire 160 for transmitting a locking pin indication signal to an operator's cabin 2. According to one embodiment a first locking pin position indication signal is transmitted to the operator's cabin 2 wirelessly via the central radio unit 26, or via the wire 160.

FIGS. 11a, 12a, 13a shows a perspective view of a first or second locking pin 13a, 13b in engagement with a first or second spring device 17a, 17b, according to an embodiment. FIGS. 11b-11d, 12b-12d, 13b-13d, shows side views of a first or second locking pin 13a, 13b according to FIG. 11a, 12a, 13a, respectively. As the first and second locking 13a, 13b are identical according to one embodiment, only the first locking pin 13a will be presented in more detail as follows. The corresponding second locking pin 13b and references follows from the figures. Thus, according to one embodiment, what is described herein relating to the first locking pin 13a applies analogously for the second locking pin 13b. According to one embodiment, the first locking pin 13a is for a lock indicator arrangement 100 as described herein.

According to one embodiment, the first locking pin 13a comprises a first locking pin center axis 13a′, extending in a first locking pin extension direction. According to one embodiment, the first locking pin 13a comprises a first distal end portion 14a comprising a first wedge surface portion 15a. According to one embodiment, the first locking pin 13a is essentially cylinder shaped. According to one embodiment, a surface portion 27a of the first locking pin 13a comprises first guiding groove 28a comprising a first extension guiding groove section 30a extending along the first locking pin extension direction. According to one embodiment, the first extension guiding groove section 30a is configured to engage with a first spring ball device 175a comprising a first ball 170a and a first spring device 17a, biasing the first locking pin 13a towards a first rotation position during an attachment of the tool 20. Further, FIGS. 11a-13d, with reference to the second locking pin 13b, further shows a second ball 170b, a second spring device 17b, a second spring ball device 175b.

According to one embodiment, the first guiding groove 28a further comprises a first retraction guiding groove section 31a extending with a groove angle γ in relation to the first extension direction, wherein the first retraction guiding groove section 31a is configured to engage with the first spring ball device 175a, guiding the first locking pin 13a towards a first rotation position during a linear movement towards a retracted position of the first locking pin 13a. According to one embodiment, the groove angle γ is in the interval of 95°≤γ≤175°, preferably 105°≤γ≤165°, more preferably 115°≤γ≤155°. According to one embodiment, the angle γ, depth of the groove, size of the first ball 170a and spring force of the first spring device 17a in relation to the first ball 170a is selected to optimize the force or biasing force acting to rotate the first locking pin 13a during a movement between a retracted and extended position of the first locking pin 13a.

As shown in FIG. 11a-11d, the first locking pin 13a is in a first rotation position, according to an embodiment. According to one embodiment, the first locking pin 13a is in a retracted position. As shown particularly clearly in FIG. 11b, the first locking pin 13a is in maximal counterclockwise rotation position, which, in this embodiment is a first rotation position. According to one embodiment, the first guiding groove 28a solely comprises a first extension guiding groove section 30a. In such case, the first rotation position is reached when a distal end of the first extension guiding groove section 30a engages with the first spring ball device 175a, and as a result of the spring force of the spring device 17a causing the rotation of the first locking pin 13a to the first rotation position. As will be described below, with a first retraction guiding groove section 31a, a first rotation position is reachable which is a rotation in a counterclockwise direction beyond that described above with only a first extension guiding groove section 30a. A benefit of this is that the first rotation position is distinctly different from other intermediate rotation positions and a sensing device may be configured to determine a retraction position in a more reliable manner. During, e.g. a linear retracting movement of the first locking pin 13a, the first retraction guiding groove section 31a, such as the distal edge of the retraction guiding groove section 31a engages with the first spring ball device 175a. The spring force of the first spring ball device 175a acting on the distal edge of the retraction guiding groove section 31a forces the first locking pin 13a to rotate towards a first rotation position, i.e. the engagement between the first retraction guiding groove section 31a and the first spring ball device 175a guides the first locking pin 13a towards a first rotation position. According to one embodiment, the first rotation position has been reached when the first locking pin 13a has been fully retracted to a retracted position, and the first spring ball device 175a has reached a distal end position of the first guiding groove 28a. In this embodiment, when the first spring ball device 175a has reached a distal end position of the first retraction guiding groove section 31a. According to one embodiment, the angle γ provides continues acting of the first spring ball device 175a against a distal edge of the retraction guiding groove section 31a during the linear retracting movement of the first locking pin 13a.

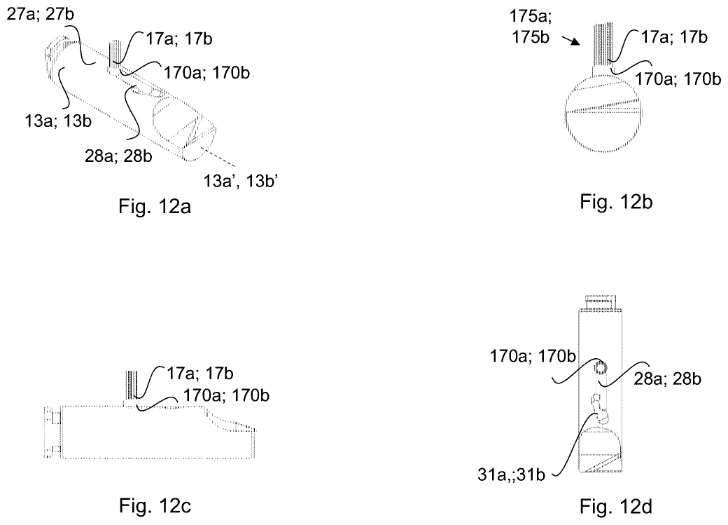

FIG. 12a shows a perspective view of a first or second locking pin 13a, 13b in engagement with a first or second spring device 17a, 17b according to an embodiment. FIGS. 12b-12d shows side views of a first or second locking pin 13a, 13b, according to FIG. 12a. As shown, particularly clearly in FIG. 12b, the first locking pin 13a is in an extended position, and an intermediate rotation position. During e.g. a linear extension movement of the first locking pin 13a, the first locking pin 13a has reached an extended position, as e.g. can be seen in FIG. 12d. Thus, according to one embodiment, this indicates an incorrect locking of a tool, or no locking at all, as the first locking pin 13a has not been brought to rotate into a second rotation position. For instance, no engagement between the first locking pin 13a and a first attachment device 22a has occurred. During this movement, from the retracted position of the first locking pin 13a, the first retraction guiding groove section 31a, such as a proximal edge of the retraction guiding groove section 31a engages with the first spring ball device 175a. The spring force of the first spring ball device 175a acting on the proximal edge of the retraction guiding groove section 31a forces the first locking pin 13a to rotate towards an intermediate rotation position, i.e. the engagement between the first retraction guiding groove section 31a and the first spring ball device 175a guides the first locking pin 13a towards an intermediate rotation position. Thus, the first locking pin 13a is configured to be caused to rotate a part of the rotation from the first rotation position to the second rotation position by an engagement between a first retraction guiding groove section 31a and a first spring ball device 175a. According to one embodiment, a part of the rotation from the first rotation position to the second rotation position comprises a rotation between a first rotation position to an intermediate rotation position. According to one embodiment, a part of the rotation from the first rotation position to the second rotation position comprises a rotation from a first rotation position to an intermediate rotation position. According to one embodiment, the engagement between a first retraction guiding groove section 31a and a first spring ball device 175a, and the engagement of the first locking pin 13a, with the first attachment device 22a provides for the entire rotation from the first rotation position to the second rotation position. This applies analogously to the second locking pin 13b. According to one embodiment, “to” and “up to” are used interchangeably. Thus, according to an embodiment, the movement from a first rotation position to an intermediate rotation position does not require the engagement of the locking pin 13a with a first attachment device 22a. According to one embodiment, the intermediate rotation position has been reached when the first locking pin 13a has reached an intermediate extension position between the retracted and extended position. According to one embodiment an intermediate extension position is any position between an extended and retracted position. According to one embodiment, an intermediate extension position of the first locking pin 13a has been reached when first extension guiding groove section 30a engages with the first spring ball device 175a. According one embodiment, any position of the first locking pin 13a wherein the first extension groove section 30a engages with the first spring ball device 175a, except a retracted and extended position, is an intermediate extension position. As shown in FIGS. 12a-12d, the first locking pin 13a has moved in an extension direction to the point where a distal end of the first extension guiding groove 30a engages with the first spring ball device 175a. According to one embodiment, during the movement of the first locking pin 13a in an extension direction, an engagement of the first locking pin 13a with a first attachment device 22a will cause the first locking pin 13a to rotate towards a second rotation position, and a side wall portion of the first extension groove portion 30a will engage with the first spring ball device 175a to increasingly compress the first spring device 17a of the first spring ball device 175a. This causes the first locking pin 13a to be biased towards a first rotation position.

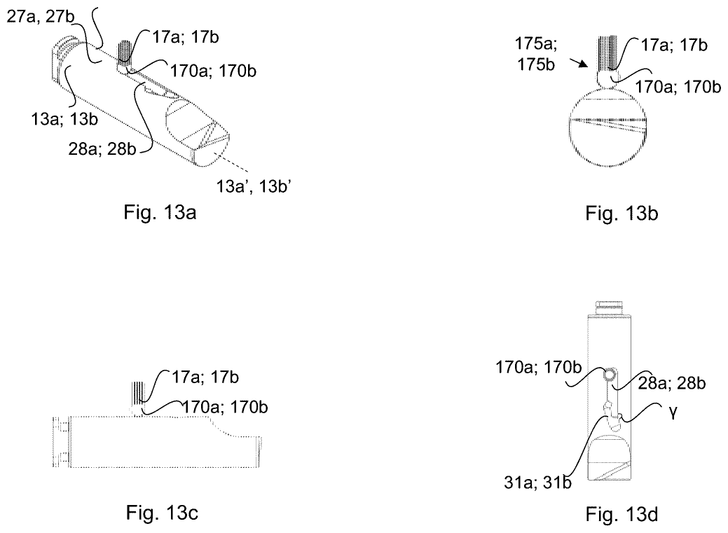

FIG. 13a shows a perspective view of a first or second locking pin 13a, 13b, in engagement with a first or second spring device 17a, 17b, respectively, according to an embodiment. FIGS. 13b-13d shows side views of a first or second locking pin 13a, 13b according to FIG. 13a. As shown, particularly clearly in FIG. 13b, the first locking pin 13a is in a second rotation position. According to one embodiment, the first locking pin 13a is in an extended position, as e.g. can be seen in FIG. 13d. During e.g. a linear extension movement of the first locking pin 13a, the first locking pin 13a has reached an extended position. During this movement, from the intermediate extension position of the first locking pin 13a, an engagement with the first locking pin 13a with a first attachment device 22a will cause the first locking pin 13a to rotate towards a second rotation position, and a side wall portion of the first extension groove portion 30a will engage with the first spring ball device 175a to increasingly compress the first spring device 17a of the first spring ball device 175a. This causes the first locking pin 13a to be biased towards a first rotation position. Eventually, the rotation of the first locking pin 13a, will reach a second rotation position. According to one embodiment, the rotation has herein led to an engagement of the side wall portion of the first extension groove portion 30a with the first spring ball device 175a that causes the first spring device 17a to compress and the spring ball device 175a to reach almost to an upper edge of the side wall portion as can be seen in FIGS. 13c-13d, wherein almost the entire first ball 170a is visible. According to one embodiment, a maximum biasing force towards a first rotation position available in the movement between a retracted and extended position of the first locking pin 13a has hereby been reached. According to one embodiment, the extended position and the second rotation position of the first locking pin 13a forms a locked position of the tool 20. According to one embodiment, in an incorrect locking procedure of the tool 20 corresponding e.g. to FIG. 7a, wherein no engagement between the first locking pin 13a and a first attachment device 22a occurs that will cause the first locking pin 13a to rotate, the first spring ball device 175a will slide along the first extension groove portion 30a during an extension movement. Eventually, the position corresponding to that of FIG. 12d will be reached as described above.

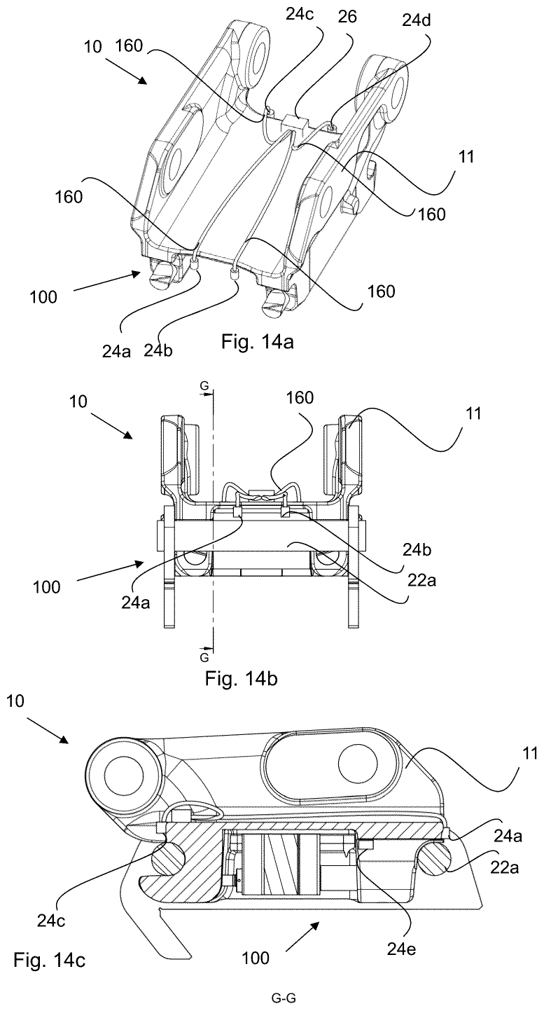

FIG. 14a shows a perspective view of a quick coupler 10 for attaching a tool 20 to a working machine 1, according to one embodiment, comprising a central radio unit 26. According to one embodiment, the quick coupler 10 further comprises a frame 11 with a first tool receiving portion 12 for receiving the first attachment device 22a, wherein the quick coupler 10 further comprising a central radio unit 26 arranged on the frame 11 configured to transmit radio signals comprising data from the first and second sensor devices 16a, 16b. According to one embodiment, the data comprises rotation position data indicative of the rotation position of the first locking pin 13a, e.g. whether the first locking pin 13a is in a first or second rotation position. According to one embodiment, the data comprises rotation position data indicative of the rotation position of the second locking pin 13b, e.g. whether the second locking pin 13b is in a first or second rotation position. According to one embodiment, the central radio unit 26 is configured to transmit locking pin position indication signals indicative of the first and/or second locking pin 13a, 13b rotation position wirelessly to an operator's cabin 2 of the working machine 1. According to one embodiment, the first sensor device 16a and/or second sensor device 16b is connected to the central radio unit 26 by a wire 160 as described in connection with FIG. 10b. According to one embodiment, the central radio unit 26 arranged on the frame 11 at a surface portion between two walls of the frame 11. According to one embodiment, the central radio unit 26 is arranged on the frame 11 an edge portion of the frame 11. According to one embodiment, this provides a location where the radio signals transmitted from the central radio unit 26 are not or at least less attenuated or shielded by the quick coupler 10 or parts thereof. Thus, a more reliable quick coupler 10 is provided. According to one embodiment, by using a central radio unit 26 the arrangement or quick coupler do not require electrical swivel devices to enable rotational movement of the tool with maintained sensing capabilities, especially in tilt rotator applications.

FIG. 14b shows a side view of a quick coupler according to FIG. 14a. According to one embodiment, the tool 20 comprises an attachment bracket 21 comprising a first attachment device 22a and a second attachment device 22b. According to one embodiment, the quick coupler 10 comprises at least one proximity sensor device 24a, 24b, 24c, 24d, 24e configured for sensing an engagement between the quick coupler 10 and the first attachment device 22a, wherein the at least one proximity sensor devices 24a, 24b, 24c, 24d, 24e is connected to the central radio unit 26. According to one embodiment, at least one proximity sensor device 24a, 24b, 24c, 24d, 24e is located in the vicinity of the first tool receiving portion 12. According to one embodiment, the quick coupler 10 comprises a plurality of proximity sensor device 24a, 24b, 24c, 24d, 24e configured for sensing an engagement between the quick coupler 10 and the first attachment device 22a, wherein the plurality of proximity sensor devices 24a, 24b, 24c, 24d, 24e are connected to the central radio unit 26. According to one embodiment, the plurality of proximity sensor device 24a, 24b, 24c, 24d, 24e are located in the vicinity of the first tool receiving portion 12.

According to one embodiment, the quick coupler 10 comprises at least one proximity sensor device 24a, 24b, 24c, 24d, 24e configured for sensing an engagement between the quick coupler 10 and the second attachment device 22a, wherein the at least one proximity sensor device 24a, 24b, 24c, 24d, 24e is connected to the central radio unit 26. According to one embodiment, at least one proximity sensor device 24a, 24b, 24c, 24d, 24e is located in the vicinity of the second tool receiving portion 12′. According to one embodiment, the quick coupler 10 comprises a plurality of proximity sensor device 24a, 24b, 24c, 24d, 24e configured for sensing an engagement between the quick coupler 10 and the second attachment device 22b, wherein the plurality of proximity sensor devices 24a, 24b, 24c, 24d, 24e are connected to the central radio unit 26. According to one embodiment, the plurality of proximity sensor device 24a, 24b, 24c, 24d, 24e are located in the vicinity of the second tool receiving portion 12′.

According to one embodiment, the proximity sensors 24a, 24b, 24c, 24d, 24e described herein is a sensor able to detect the presence or sense the proximity of a first and/or second attachment device 22a, 22b. According to one embodiment, the proximity sensor 24a, 24b, 24c, 24d, 24e is an inductive or capacity proximity sensor. According to one embodiment, sensing the engagement between the quick coupler 10 and the first attachment pin 22a comprises sensing the proximity of the first attachment device 22a by at least one, or a plurality of proximity sensor devices 24a, 24b, 24c, 24d, 24e. According to one embodiment, sensing the engagement between the quick coupler 10 and the second attachment pin 22b comprises sensing the proximity of the second attachment device 22b by at least one, or a plurality of proximity sensor devices 24a, 24b, 24c, 24d, 24e. According to one embodiment, at least one of, or a plurality of the proximity sensor devices 24a, 24b, 24c, 24d, are configured to sense the proximity of a portion of the first and second attachment device 22a, 22b

FIG. 14c shows a cross-section view of a quick coupler along line G-G, according to FIG. 14b. According to one embodiment, as seen herein, a proximity sensor device 24e is configured to sense the extended position of the first and/or second locking pin 13a, 13b. According to one embodiment, the proximity sensor device 24e is configured to sense the position of the yoke 18 in an extended position, corresponding to the extended position of the first and second locking pin 13a, 13b. According to one embodiment, a least one, or a plurality of the proximity sensor devices 24a, 24b, 24c, 24d, 24e are connected to the radio unit by wire 160. According to one embodiment, at least one of, or a plurality of the proximity sensor devices 24a, 24b, 24c, 24d, 24e are connected to the central radio unit 26 wirelessly. According to one embodiment, the central radio unit 26 is configured to transmit radio signals comprising data from at least one of, or a plurality of, the proximity sensor devices 24a, 24b, 24c, 24d, 24e. According to one embodiment the data comprises proximity indication data from at least one of, or a plurality of, the proximity sensor devices 24a, 24b, 24c, 24d, 24e. According to one embodiment, the central radio unit 26 is configured to transmit proximity indication signals indicative of the proximity of the first and/or second attachment device 22a, 22b wirelessly to an operator's cabin 2 of the working machine 1.

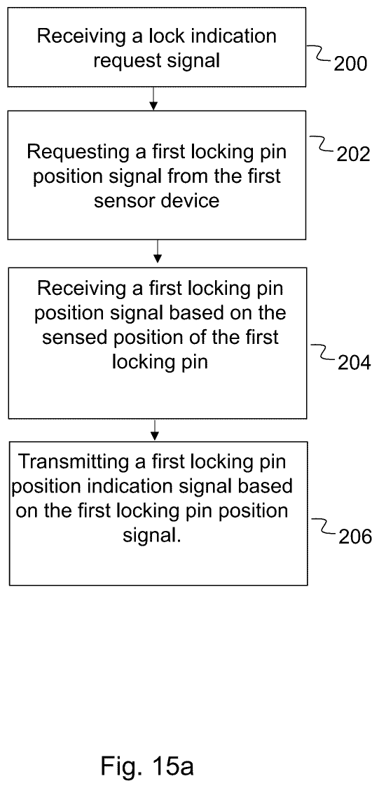

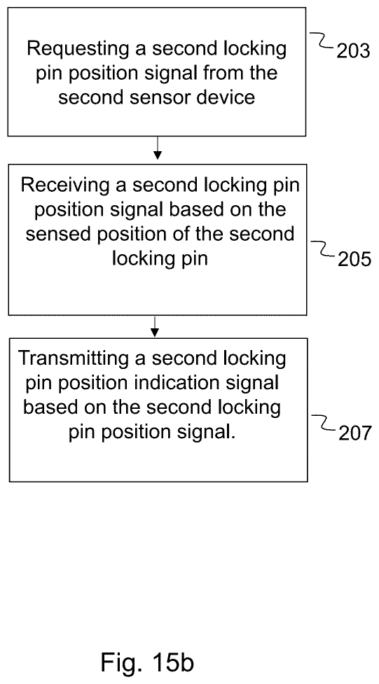

FIG. 15a shows a flow chart schematically showing method steps of an embodiment of a method performed by a lock indicator arrangement 100 for a quick coupler 10. A procedure or a method in a lock indicator arrangement 100 for a quick coupler 10 will now be described with reference to FIG. 15a. The method comprises receiving 200 a lock indication request signal. The method further comprising requesting 202 a first locking pin position signal from the first sensor device 16a. The method further comprising receiving 204 a first locking pin position signal based on the sensed position of the first locking pin 13a. The method further comprising transmitting 206 a first locking pin position indication signal based on the first locking pin position signal. According to one embodiment the first locking pin position signal comprises data from the first locking pin 13a indicative of the rotation position of the first locking pin 13a. According to one embodiment, a first locking pin position indication signal comprises data further indicating the rotation position of the first locking pin 13a. According to one embodiment, the method further comprising determining 204a the rotation position based on the first locking pin position signal.

FIG. 15b shows a flow chart schematically showing method steps of an embodiment of a method performed by a lock indicator arrangement 100 for a quick coupler 10. A procedure or a method in a lock indicator arrangement 100 for a quick coupler 10 will now be described with reference to FIG. 15b. According to one embodiment, the method further comprises requesting 203 a second locking pin position signal from the second sensor device 16b. The method further comprising receiving 205 a second locking pin position signal based on the sensed position of the second locking pin 13b. The method further comprising transmitting 207 a second locking pin position indication signal based on the second locking pin position signal. According to one embodiment, the first and second locking pin position indication signal is indicative of whether the first and second locking pin is in the first or the second rotation position. According to one embodiment the second locking pin position signal comprises data from the second locking pin 13b indicative of the rotation position of the second locking pin 13b. According to one embodiment, a second locking pin position indication signal comprises data further indicating the rotation position of the second locking pin 13b. According to one embodiment, the method further comprises determining 205a the rotation position based on the first locking pin position signal. According to one embodiment, the first and second locking pin position indication signal is transmitted to an operator's cabin 2 of a working machine 1. According to one embodiment, the first and second locking pin position indication signal is transmitted to the operator's cabin 2 wirelessly via the first and second radio unit 23a, 23b, respectively or via a wire. According to one embodiment, the first and second locking pin position indication signal is transmitted to the operator's cabin 2 wirelessly via the central radio unit 26. According to one embodiment, the first locking pin position indication signal is indicative of whether first locking pin is in the first or the second rotation position. According to one embodiment, the first locking pin position indication signal is transmitted to an operator's cabin 2 of a working machine 1. According to one embodiment, the first locking pin position indication signal is transmitted to the operator's cabin 2 wirelessly via the first radio unit 23a, or via a wire. According to one embodiment, the first locking pin position indication signal is transmitted to the operator's cabin 2 wirelessly via the central radio unit 26. According to one embodiment, the second locking pin position indication signal is indicative of whether second locking pin is in the first or the second rotation position. According to one embodiment, the second locking pin position indication signal is transmitted to an operator's cabin 2 of a working machine 1. According to one embodiment, the second locking pin position indication signal is transmitted to the operator's cabin 2 wirelessly via the second radio unit 23b, or via a wire. According to one embodiment, the second locking pin position indication signal is transmitted to the operator's cabin 2 wirelessly via the central radio unit 26.

According to one embodiment, the lock indication request signal is generated by an operator that wants to connect and lock a tool 20 to the quick coupler 10 and actuates an actuation device for retracting or opening the first and second locking pins 13a, 13b, such as e.g actuating a button in the operator's cabin 2. According to one embodiment, the normal position of the first and second locking pin 13a, 13b is an extended position even when no tool 20 is locked to the quick coupler 10. Upon actuation, the first and second locking pins 13a, 13b are moved to the retracted position. In this case, the first and/or the second locking pin position indication signals indicates that the first and/or second locking pin 13a, 13b is in the first rotation position. A display in the operator's cabin, showing a simple graphic model of the quick coupler 10, comprising a portion corresponding to the locking device 19 or the first and second locking pin 13a, 13b indicating at least one of their positions by colors, such as e.g. the colors green, yellow, red. According to one embodiment, a normal extended position without a tool 20 locked to the quick coupler 10 is indicated by a red portion in the graphic model “Not Locked”. According to one embodiment, the first rotation position is indicated by a yellow portion in the graphic model, “Open”. According to an embodiment, where the sensor devices are not configured to sense the first rotation position, the first rotation position of at least one of the first and second locking pin 13a, 13b is indicated by a red portion “Not locked”. The operator then locates the tool/attachment device 22a in the tool receiving portion 12.

Upon actuation of an actuator for locking the tool or extending the first and second locking pin 13a, 13b, the first and second locking pin 13a, 13b move towards the extended position. Upon leaving the first rotation position, at least one of a first and second sensor device for sensing the first position and/or a sensor for indicating an intermediate extension position provides a position indication signal that at least one of the first and second locking pin 13a, 13b is no longer in the first rotation position, i.e. being in an intermediate extension position. According to one embodiment, a sensor for indicating an intermediate extension position may be used in embodiments of a first and second locking pin 13a, 13b with a guiding groove 28a, 28b solely comprising an extension guiding groove section and no retraction guiding groove section. According to one embodiment, this position is indicated by a red portion in the graphic model, “Not locked”. This indication continues until the first and second locking pin 13a, 13b have moved to an extended position and a second rotation position, respectively, wherein the indication changes to green, “Locked”. The operator may hereafter safely use the tool 20 locked to the quick coupler.

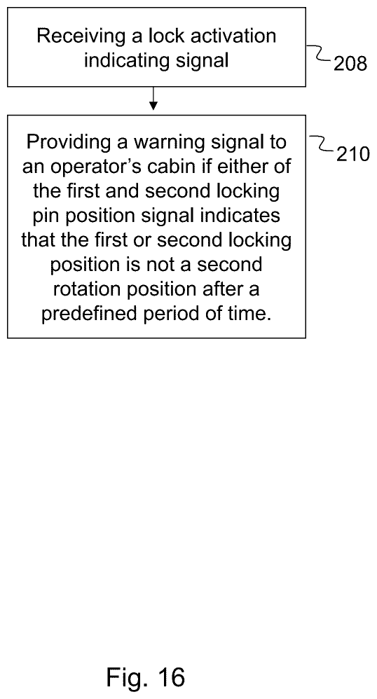

FIG. 16 shows a flow chart schematically showing method steps of an embodiment of a method performed by a lock indicator arrangement 100 for a quick coupler 10. A procedure or a method in a lock indicator arrangement 100 for a quick coupler 10 will now be described with reference to FIG. 16. According to one embodiment, the method further comprising receiving 208 a lock activation indicating signal. According to one embodiment, the lock activation indication signal is a signal indicating that the operator has actuated and actuator for locking the tool 20 or extending the first and second locking pin 13a, 13b. The method further comprising providing 210 a warning signal to an operator's cabin 2 if either of the first and second locking pin position signal indicates that the first or second locking pin position is not a second rotation position after a predefined period of time. According to one embodiment, the predefined time is zero, i.e. the red portion in the graphic model “Not Locked” is indicated directly following an actuation for locking the tool 20, i.e. receiving the lock activation indication signal as described above. According to one embodiment, the predefined time is in the interval of 0 to 2 seconds. According to one embodiment, the warning signal is any or all of an audible, visible, or haptic signal. According to one embodiment, the warning signal provides an additional warning to the operator to that of the color indication on the display in the operator's cabin described above.

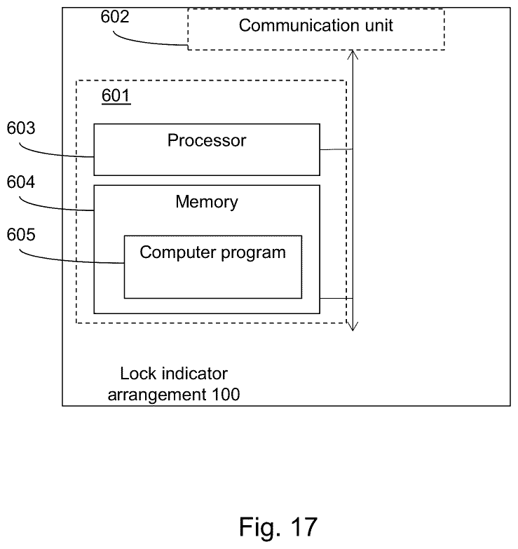

FIG. 17 shows a block schematic of a lock indicator arrangement 100 according to an embodiment. FIG. 17, e.g. in conjunction with FIG. 1, shows a lock indicator arrangement 100 for a quick coupler 10. The arrangement 100 comprises processing circuitry 603 and a memory 604. The processing circuitry 603 may comprise one or more programmable processor, application-specific integrated circuits, field programmable gate arrays or combinations of these (not shown) adapted to execute instructions. The memory contains instructions executable by said processing circuitry, whereby the lock indicator arrangement 100 is operative for receiving 200 a lock indication request signal. The arrangement 100 is further operative for requesting 202 a first locking pin position signal from the first sensor device 16a. The arrangement 100 is further operative for receiving 204 a first locking pin position signal based on the sensed position of the first locking pin 13a. The arrangement 100 is further operative for transmitting 206 a first locking pin position indication signal based on the first locking pin position signal.

According to one embodiment, the arrangement 100 is further operative for requesting 203 a second locking pin position signal from the second sensor device 16b. According to one embodiment, the arrangement 100 is further operative for receiving 205 a second locking pin position signal based on the sensed position of the second locking pin 13b. According to one embodiment, the arrangement is further operative for transmitting 207 a second locking pin position indication signal based on the second locking pin position signal.

According to one embodiment, the arrangement is further operative for receiving 208 a lock activation indicating signal. According to one embodiment, the arrangement is further operative for providing 210 a warning signal to an operator's cabin 2 if either of the first and second locking pin position signal indicates that the first or second locking pin position is not a second rotation position after a predefined period of time.

In some embodiments, the feature(s) of the arrangement 100, e.g. the processing circuitry and the memory, which perform the method steps may be a group of network nodes, wherein functionality for performing the method are spread out over different physical, or virtual, nodes of the network. In other words, the feature(s) of the arrangement 100 which perform the method steps may be a cloud-solution, i.e. the feature(s) of the arrangement 100 which perform the method steps may be deployed as cloud computing resources that may be distributed in the network. According to one embodiment the different nodes of the network comprises entities within one or several arrangements 100 in radio frequency communication.

According to other embodiments, the arrangement 100 may further comprise a communication unit 602, which may be considered to comprise conventional means for communicating with relevant entities, such as other computers or devices or control units, to which it is operatively connected, including such computers, devices or control units located in the operator's cabin 2. Such entities may comprise other similar arrangement 100. In an embodiment the communication unit 602 may comprise chip set adopted for communication via CAN bus (Controller Area Network) or communication adopted to ISO 11898. Other examples of standards which may be supported by the communication interface 265 are: ZigBee, Bluetooth, Bluetooth low energy (BLE), RFID (Radio frequency identification), USB (Universal serial bus), or IEEE 802.11 (Institute of Electrical and Electronics Engineers), including but not limited to 802.11a/b/n or other similar forthcoming standards. The communication unit 602 may comprise an antenna. The communication unit 602 may be connectable to an external antenna. The instructions executable by said processing circuitry 603 may be arranged as a computer program 605 stored e.g. in the memory 604. The processing circuitry 603 and the memory 604 may be arranged in a sub-arrangement 601. The sub-arrangement 601 may be a micro-processor and adequate software and storage therefore, a Programmable Logic Device, PLD, or other electronic component(s)/processing circuit(s) configured to perform the methods mentioned above. According to one embodiment, the processing circuitry 603 may comprise a single Central Processing Unit (CPU), or could comprise two or more processing units. For example, the processing circuitry 603 may include general purpose microprocessors, instruction set processors and/or related chips sets and/or special purpose microprocessors such as Application Specific Integrated Circuits (ASICs). The processing circuitry 603 may also comprise a storage for caching purposes. According to some embodiments, the arrangement 100 comprises further functionality useful for the arrangement 100 to serve its purpose, such as power supply, internal communications bus, internal cooling, database engine, operating system, not limiting to other functionalities.

The computer program 605 may comprise computer readable code means, which when run in an arrangement 100 causes the arrangement 100 to perform the steps described in any of the described embodiments of the arrangement 100. The computer program 605 may be carried by a computer program product connectable to the processing circuitry 603. The computer program product may be the memory 604. The memory 604 may be realized as for example a RAM (Random-access memory), ROM (Read-Only Memory) or an EEPROM (Electrical Erasable Programmable ROM). Further, the computer program may be carried by a separate computer-readable medium, such as a CD, DVD or flash memory, from which the program could be downloaded into the memory 604. Alternatively, the computer program may be stored on a server or any other entity connected to the arrangement 100, to which the arrangement 100 has access via the communication unit 602. The computer program may then be downloaded from the server into the memory 604.

Although the description above contains a plurality of specificities, these should not be construed as limiting the scope of the concept described herein but as merely providing illustrations of some exemplifying embodiments of the described concept. It will be appreciated that the scope of the presently described concept fully encompasses other embodiments which may become obvious to those skilled in the art, and that the scope of the presently described concept is accordingly not to be limited. Reference to an element in the singular is not intended to mean “one and only one” unless explicitly so stated, but rather “one or more”. All structural and functional equivalents to the elements of the above-described embodiments that are known to those of ordinary skill in the art are expressly incorporated herein by reference and are intended to be encompassed hereby. Moreover, it is not necessary for an apparatus or method to address each and every problem sought to be solved by the presently described concept, for it to be encompassed hereby.

A preferred embodiment of a method, arrangement, computer program, carrier, according to the invention has been described. However, the person skilled in the art realizes that this can be varied within the scope of the appended claims without departing from the inventive idea.

All the described alternative embodiments above or parts of an embodiment can be freely combined without departing from the inventive idea as long as the combination is not contradictory.

1-34. (canceled)

35. A lock indicator arrangement (100) for a quick coupler (10) for attaching a tool (20) to a working machine (1), the tool (20) comprising an attachment bracket (21) comprising a first attachment device (22a), wherein the quick coupler (10) further comprises a frame (11) with a first tool receiving portion (12) for receiving the first attachment device (22a),
the lock indicator arrangement (100) comprises a locking device (19), comprising a first locking pin and second locking pin (13a, 13b), wherein the first locking pin and second locking pin (13a, 13b) comprises a first locking pin center axis (13a′) and a second locking pin center axis (13b′), respectively, extending in a first locking pin extension direction and a second locking pin extension direction, respectively,
wherein the locking device (19) is configured to move in relation to the frame (11), wherein the first locking pin and the second locking pin (13a, 13b) are configured to move between a retracted position and an extended position, respectively, in the first locking pin extension direction and second locking pin extension direction, respectively, wherein the first and second locking pins (13a, 13b) delimit the first tool receiving portion (12) in their extended positions, respectively, wherein the first locking pin (13a) is configured to rotate around the first locking pin center axis (13a′), in relation to the frame (11), between a first and second rotation position, wherein the first and second locking pin (13a, 13b) comprises a first and second distal end portion (14a, 14b) comprising a first and second wedge surface portion (15a, 15b), respectively, configured to engage with the first attachment device (22a) of the tool (20), during an attachment of the tool (20), wherein the first locking pin (13a) is configured to rotate from the first rotation position to the second rotation position, during the movement from the retracted to the extended position, when the first wedge surface portion (15a) engage with the first attachment device (22a), wherein the extended position and second rotation position of the first locking pin (13a), forms a locked position of the tool (20) received in the first tool receiving portion (12),
wherein the lock indicator arrangement (100) further comprises a first sensor device (16a), wherein the first sensor device (16a) is configured to sense at least when the first locking pin (13a), is in the second rotation position.

36. The lock indicator arrangement (100) according to claim 35, wherein the second locking pin (13b) is configured to rotate around the second locking pin center axis (13b′), in relation to the frame (11) between a first and second rotation position, wherein the second locking pin (13b) is configured to rotate from the first rotation position to the second rotation position, during the movement from the retracted to the extended position, when the second wedge surface portion (15b) engage with the first attachment device (22a), wherein the extended position and second rotation position of the second locking pin (13a), forms a locked position of the tool (20) received in the first tool receiving portion (12), wherein the lock indicator arrangement (100) further comprises a second sensor device (16b), wherein the second sensor device (16b) is configured to sense at least when the second locking pin (13b), is in the second rotation position.

37. The lock indicator arrangement (100) according to claim 36, wherein the first and second locking pins (13a, 13b) are biased towards the first rotation position by a first and second spring device (17a, 17b), respectively.

38. The lock indicator arrangement (100) according to claim 35, wherein the first and second locking pins (13a, 13b) are configured to rotate independently of each other.

39. The lock indicator arrangement (100) according to claim 35, wherein the first and second sensor devices (16a, 16b) are arranged inside the first and second locking pins (13a, 13b), respectively.

40. The lock indicator arrangement (100) according to claim 35, wherein the first and second sensor devices (16a, 16b) are arranged inside a yoke (18) of the locking device (19).

41. The lock indicator arrangement (100) according to claim 35, wherein the first and second wedge surface portions (15a, 15b) are configured to engage with a first attachment device engagement surface portion (22aₛₚ), wherein the first and second wedge surface portions (15a, 15b) comprise a first and second wedge surface portion plane with a first and second wedge surface plane outward normal direction (15a_{n,} 15bₙ), respectively, wherein the first attachment device engagement surface portion (22aₛₚ) has a first attachment device engagement surface portion inward normal direction (22aₛₚᵢₙ) wherein the first and second wedge surface portion plane outward normal direction (15a_{n,} 15bₙ) are arranged with an angle (α₁, α₂), respectively, in relation to the first attachment device engagement surface portion inward normal direction (22aₛₚᵢₙ) during the attachment of the tool (20), wherein the angles (α₁, α₂) are in the interval of 0°<(α₁, α₂)≤90°, in the first rotation positions.

42. The lock indicator arrangement (100) according to claim 41, wherein the angles (α₁, α₂)=0° in the second rotation positions.

43. The lock indicator arrangement (100) according to claim 35, wherein the first and second locking pin (13a, 13b) comprises a first and second guiding wedge surface portion (15a_{g}, 15b_{g}), respectively, wherein the first and second guiding wedge surface portion (15a_{g}, 15b_{g}) comprise a first and second guiding wedge surface portion plane with a first and second guiding wedge surface portion plane outward normal direction (15a_{gn,} 15b_{gn}), respectively, wherein the first and second guiding wedge surface portion plane outward normal direction (15a_{gn,} 15b_{gn}) are arranged with an angle (β₁, β₂), respectively, in relation to the first attachment device engagement surface portion inward normal direction (22aₛₚᵢₙ) in the first rotation positions during the attachment of the tool (20), wherein β₁<α₁, and β₂<α₂.

44. The lock indicator arrangement (100) according to claim 35, wherein the angles (β₁, β₂)=0° in the first rotation positions.

45. The lock indicator arrangement (100), according to claim 36, wherein the first and second locking pin (13a, 13b) comprises a first and second radio unit (23a, 23b), a first and second battery device (25a, 25b) and the first and second sensor device (16a, 16b), respectively, wherein the first and second radio units (23a, 23b) are configured to transmit radio signals comprising data from the first and second sensor devices (16a, 16b), respectively.

46. The lock indicator arrangement (100) according to claim 35, wherein the first locking pin (13a) is in a first rotation position when the first locking pin (13a) is in a retracted position.

47. A quick coupler (10) for attaching a tool (20), comprising a lock indicator arrangement (100) according to claim 35.

48. The quick coupler (10) according to claim 47, further comprising a central radio unit (26) arranged on the frame (11), configured to transmit radio signals comprising data from the first and second sensor devices (16a, 16b).

49. The quick coupler (10) according to claim 48, further comprising at least one proximity sensor device (24a, 24b, 24c, 24d, 24e) configured for sensing an engagement between the quick coupler (10) and at least the first attachment device (22a), wherein the at least one proximity sensor device is connected to the central radio unit (26), wherein the central radio unit (26) is further configured to transmit radio signals comprising data from the at least one proximity sensor device (24a, 24b, 24c, 24d, 24e).

50. A working machine (1) comprising a quick coupler (10) according to claim 47.

51. A method performed by a lock indicator arrangement (100) for a quick coupler (10), according to claim 35, the method comprising:
receiving (200) a lock indication request signal,
requesting (202) a first locking pin position signal from the first sensor device (16a),
receiving (204) a first locking pin position signal based on the sensed position of the first locking pin (13a, 13b), respectively,
transmitting (206) a first locking pin position indication signal based on the first locking pin position signal.

52. The method according to claim 50, wherein the method further comprising:
requesting (203) a second locking pin position signal from the second sensor device (16b),
receiving (205) a second locking pin position signal based on the sensed position of the second locking pin (3b),
transmitting (207) a second locking pin position indication signal based on the second locking pin position signal.

53. The method according to claim 52, wherein the first and second locking pin position indication signal is indicative of whether the first and second locking pin is in the first or the second rotation position.

54. The method according to claim 51, wherein the first and second locking pin position indication signal is transmitted to an operator's cabin (2) of a working machine (1).

55. The method according to claim 54, wherein the first and second locking pin position indication signal is transmitted to the operator's cabin (2) wirelessly via a radio unit, or via a wire.

56. The method according to claim 51, wherein the method further comprises:
receiving (208) a lock activation indicating signal,
providing (210) a warning signal to an operator's cabin (2) if either of the first and second locking pin position signal indicates that the first or second locking pin position is not a second rotation position after a predefined period of time.

57. The method according to claim 56, wherein the warning signal is any or all of an audible, visible, or haptic signal.

58. A lock indicator arrangement (100) according to claim 35, further comprising:
processing circuitry (603); and
a memory (604), said memory (604) containing instructions executable by said processing circuitry (603), whereby said arrangement (100) is operative for:
receiving (200) a lock indication request signal,
requesting (202) a first locking pin position signal from the first sensor device (16a),
receiving (204) a first locking pin position signal based on the sensed position of the first locking pin (13a),
transmitting (206) a first locking pin position indication signal based on the first locking pin position signal.

59. The lock indicator arrangement (100) according to claim 58, further operative for
requesting (203) a second locking pin position signal from the second sensor device (16b),
receiving (205) a second locking pin position signal based on the sensed position of the second locking pin (13b),
transmitting (207) a second locking pin position indication signal based on the second locking pin position signal.

60. The lock indicator arrangement (100) according to claim 59, wherein the first and second locking pin position indication signal is indicative of whether the first and second locking pin is in the first or the second rotation position.

61. A computer program (605) comprising computer readable code means to be run in a lock indicator arrangement (100) for a quick coupler (10) for attaching a tool (20) to a working machine (1), which computer readable code means when run in the arrangement (100) causes the arrangement (100) to carry out the method according to claim 51.

62. A carrier containing the computer program (605) according to claim 61, wherein the carrier is one of an electronic signal, optical signal, radio signal or computer readable storage medium.

63. A first locking pin (13a) for a lock indicator arrangement (100) according to claim 35, comprising a first locking pin center axis (13a′), extending in a first locking pin extension direction, a first distal end portion (14a) comprising a first wedge surface portion (15a), wherein the first locking pin (13a) is essentially cylinder shaped, wherein a surface portion (27a) of the first locking pin (13a) comprises a first guiding groove (28a) comprising a first extension guiding groove section (30a) extending along the first locking pin extension direction, wherein the first extension guiding groove section (30a) is configured to engage with a first spring ball device (175a) comprising a first ball (170a) and a first spring device (17a), biasing the first locking pin (13a) towards a first rotation position during an attachment of the tool (20).

64. The first locking pin (13a) according to claim 63, wherein the first guiding groove (28a) further comprises a first retraction guiding groove section (31a) extending with a groove angle (γ) in relation to the first extension direction, wherein the first retraction guiding groove section (31a) is configured to engage with the first spring ball device (175), forcing the first locking pin (13a) towards the first rotation position during a movement towards a retracted position of the first locking pin (13a).

65. The first locking pin according to claim 63, wherein the groove angle (γ) is in the interval of 95°≤γ≤175°.

66. The first locking pin according to claim 63, wherein the first locking pin (13a) comprises a first radio unit (23a), a first battery device (25a) and the first sensor device (16a), wherein the first radio unit (23a) is configured to transmit radio signals comprising data from the first sensor device (16a), respectively.

67. The first locking pin (13a) according to claim 63, wherein the radio unit (23a) is arranged at the first distal end portion (14a), and the first sensor device (16a) is arranged at a proximal end portion (14c), wherein the first battery device (25a) is arranged between the first radio unit (23a) and the first sensor device (23a).

68. The first locking pin (13a) according to claim 63, further comprising an opening (27) configured to enable access to the first battery device (25a) for replacing the first battery device (25a) via an openable lid (270) configured to cover the opening (27).
